(19) United States
(12) Patent Application Publication
(10) Pub. No.: US 2012/0084388 A1
(43) Pub. Date: Apr. 5, 2012

(54) INTER UE TRANSFER BETWEEN MOBILE INTERNET PROTOCOL CLIENTS

(76) Inventors: Xavier De Foy, Kirkland, CA (US); Michelle Perras, Montreal (CA); Kamel M. Shaheen, King of Prussia, PA (US)

(21) Appl. No.: 13/078,155

(22) Filed: Apr. 1, 2011

Related U.S. Application Data
(60) Provisional application No. 61/320,458, filed on Apr. 2, 2010.
(60) Provisional application No. 61/332,513, filed on May 7, 2010.

(51) Int. Cl. G06F 15/16; H04W 8/00

(52) U.S. Cl. 709/217

(57) ABSTRACT

Mobile IP (MIP) protocol may be used to transfer a communication flow between nodes. An indication to transfer the communication flow is received at a first node, and the first node sends a communication flow transfer request via mobile internet protocol. The request is received by a network device. The network device forwards the request for delivery to the second node. The network device receives a response to the request originated from the second node via mobile internet protocol, and instructs a correspondence node to transfer the communication flow to the second node. Upon receiving a response indicating that the communication flow transfer request has been accepted, the first node terminates the communication flow at the first node. The second node resumes the transferred communication flow.

### CROSS REFERENCE TO RELATED APPLICATIONS

This application claims the benefit of U.S. Provisional Application Ser. No. 61/320,458 filed Apr. 2, 2010, and U.S. Provisional Application Ser. No. 61/332,513 filed May 7, 2010, both of which are hereby incorporated by reference herein.

### BACKGROUND

Multimedia application information, multimedia “flows” (or media flows), may be communicated to mobile nodes, mobile devices, or user equipment (UE) across one or more wireless communication networks. A media flow may be communicated from another mobile node, mobile device, or a node of a wireless communication network. Mobile device users may wish to transfer the media flow from one mobile node or UE to another mobile node or UE. For example, a mobile device user may wish to transfer a voice component of a media flow (or a media session) to another phone, and the video component of the same session to a video projector.

Such media flow transfers, or media session transfers, may be referred to as an Inter UE transfer (IUT). In IP Multimedia Subsystem (IMS) networks, IUT may be accomplished by the methods disclosed in 3GPP TS 23.237 Technical Specification Group Services and Architecture; IP Multimedia Subsystem (IMS) Service Continuity; Stage 2 (Release 10) V10.0.0 (2009-12). However, the deployment of IMS may not be pervasive in the future. Also, many network operators may choose not to deploy IMS. Additionally, there are many services that may run on 3GPP networks and IP networks that are non-IMS based such as media streaming (HTTP, RTSP, MBMS, among others).

There may be a need for session transfer between different non-IMS devices in non-IMS based services. Such non-IMS based devices may be those which use mobility protocols such as Mobile IP (MIP), or such non-IMS devices may be capable of using mobility protocols or MIP services. Currently, there is no known solution for IUT for mobile protocol based devices or clients, or MIP based devices.

### SUMMARY

Systems, methods, and instrumentalities are disclosed that may provide for transferring a communication flow via Mobile IP (MIP) protocol.

A communication flow may be transferred from a first node to a second node using MIP messages. For example, a first node may receive an indication to transfer the communication flow to a second node. The first node may send a communication flow transfer request via mobile internet protocol. For example, the communication flow transfer request may include an MIP message. The first node may receive a communication session transfer response via mobile internet protocol. For example, the response may include an MIP message. The response may indicate that the communication flow transfer request has been accepted. Based on the response, the first node may terminate the communication flow at the first node.

The MIP request message and the MIP response message may include an indicator identifying the communication flow transfer message, a type of the communication flow transfer message, and a description of the communication flow transfer message. The description of the communication flow transfer message may include the MIP address of the first node, the MIP address of the second node, an address of a correspondence node, session continuity parameter(s) and/or application specific parameters.

The request to transfer the communication flow from the first node to the second node may be received by a network device (e.g., a session central continuity function node). The network device may authorize the request, and may forward the request for delivery to the second node via mobile internet protocol. The network device may receive a response to the request indicating that the second node has accepted the request. The response may have originated from the second node via mobile internet protocol. Upon receipt of the response, the network device may instruct a correspondence node to transfer the communication flow from the first node to the second node.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2 illustrates an example embodiment of a system transferring a communication session between network nodes.

FIG. 3 illustrates example network architecture for transferring a communication session between network nodes.

FIG. 4A illustrates an example embodiment of a communication flow transfer between mobile nodes using a mobile internet protocol.

FIG. 4B illustrates example network architecture for transferring a communication session between network nodes.

FIG. 5 illustrates an example of a mobile internet protocol header.

FIG. 6 illustrates an example of a mobile node that may request a communication flow transfer using a mobile internet protocol.

FIG. 7 illustrates an example of a mobile node that may respond to a communication flow transfer request using a mobile internet protocol.

FIGS. 8-14 illustrate example network architectures supporting communication flow transfer among mobile nodes using mobile internet protocol.

FIG. 15 illustrates an example system for providing an IUT collaborative session.

FIGS. 16-32 illustrate example collaborative session actions.

FIG. 33 illustrates an example of a MIP message structure.

FIG. 34-36 illustrate examples of communication flow transfers.

### DETAILED DESCRIPTION OF ILLUSTRATIVE EMBODIMENTS

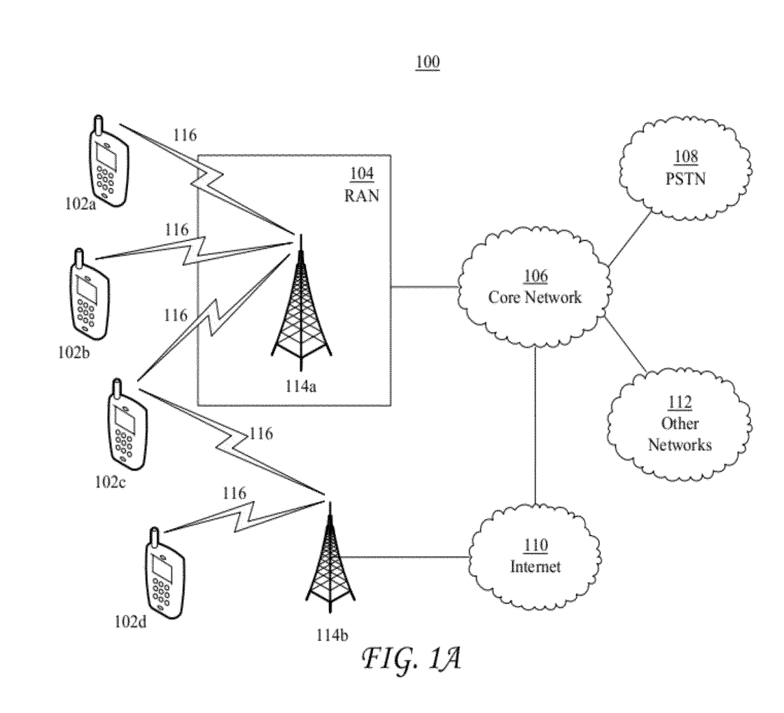

A detailed description of illustrative embodiments of the embodiments will now be described with reference to FIGS. 1-36. Although this description provides a detailed example of possible embodiments, it should be noted that the details are intended to be exemplary and in no way limit the scope of the disclosed embodiments.

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The core network 106 may include at least one transceiver and at least one processor. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b and 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 170a, 170b, 170c, though it will be appreciated that the RAN 104 may include any number of eNode-Bs while remaining consistent with an embodiment. The eNode-Bs 170a, 170b, 170c may each include one or more transceivers for communicating with the WTRUs 102a, 102b, 102c over the air interface 116. In an embodiment, the eNode-Bs 170a, 170b, 170c may implement MIMO technology. Thus, the eNode-B 140a, for example, may use multiple antennas to transmit wireless signals to, and receive wireless signals from, the WTRU 102a.

Each of the eNode-Bs 170a, 170b, 170c may be associated with a particular cell (not shown) and may be configured to handle radio resource management decisions, handover decisions, scheduling of users in the uplink and/or downlink, and the like. As shown in FIG. 1D, the eNode-Bs 170a, 170b, 170c may communicate with one another over an X2 interface.

The core network (CN) 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 170a, 170b, 170c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 170a, 170b, 170c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and an ASN gateway 142, though it will be appreciated that the RAN 104 may include any number of base stations and ASN gateways while remaining consistent with an embodiment. The base stations 180a, 180b, 180c may each be associated with a particular cell (not shown) in the RAN 104 and may each include one or more transceivers for communicating with the WTRUs 102a, 102b, 102c over the air interface 116. In one embodiment, the base stations 180a, 180b, 180c may implement MIMO technology. Thus, the base station 140a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management. The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 215 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include one or more network devices such as a mobile IP home agent (MIP-HA) 184, an authentication, authorization, accounting (AAA) server 186, and a gateway 188. While each of the foregoing elements are depicted as part of the core network 106, it will be appreciated that any one of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

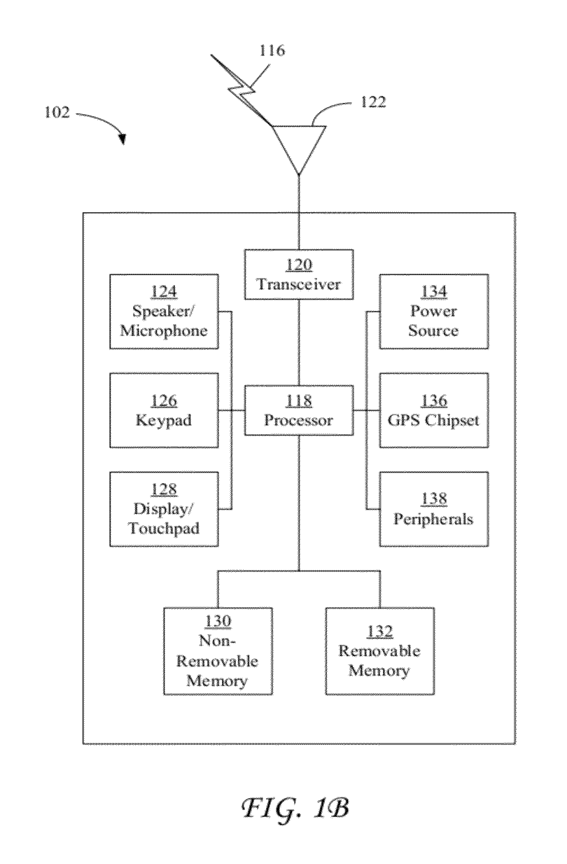

FIG. 2 illustrates an example embodiment of a system 200 transferring a communication session between network nodes. For example, media flows may be transferred from one terminal, such as the mobile device 270, to a second terminal, such as the projector 290. For example, a mobile device user may decided to transfer the voice component, such as voice component 220, of a media session to a fixed phone, such as the fixed phone 280, and the video component, such as the video component 230, of the same media session to a video projection, such as the projector 290. According to an example embodiment, the system 200 may include the IP network 210. The IP network 210 may be a network such as a Public Land Mobile Network (“PLMN”), an IMS network, corporate intranet, a Fixed-End System (“FES”), the public Internet, or the like. It should be noted that network elements such as elements such as routers, gateways switches, and/or the like, may be included within the IP network 110.

As illustrated in FIG. 2, the IP network 210 may be in operative communication with one or more mobile nodes, wireless transmit/receive units (WTRU), or UEs, such as the mobile device 270. For example, mobile device 270 may include a WTRU 102 as described in FIGS. 1A-1E. The network 210 may also be in operative communication with the fixed phone 280, the projector 290, the computer 260, or the like. The configurations and the communications between the IP network 210 and the mobile devices or WTRUs is provided for illustrative purposes, and as such, the communications between the specified WTRUs may be between different elements and/or through additional elements as well as different signaling/commands may be used.

In one example embodiment, a user associated with the mobile device 270 may establish a multimedia flow with a remote party associated with the computer 260. The multimedia flow may include one or more media components, such as the voice component 220 and/or the video component 230. The fixed line 280 and/or the projector 290 may be in operative connection with the IP network 210, the mobile device 270 and/or the computer 260. The fixed line 280 and the projector 290 may belong to one or more IMS subscriptions that differ from the IMS subscription of the mobile device 270. Additionally, the fixed line 280 and the projector 290 may belong to one or more network operators that differ from the network operator of the mobile device 270.

A multimedia flow between the fixed line 280 and/or the projector 290 may be established with the remote party, such as the computer 260. The media flow may then be received at both the fixed line 280 and/or the projector 290. In another embodiment, the media flow may be broken into components that may then be received by the fixed line 280 and/or the projector 290. For example, the voice component 220 of media flow may be transferred to the fixed line 280 and the video component of the media flow may be transferred to the projector 290. When the media flow is received at the fixed line 280 and/or the projector 290, a collaborative session 250 may then be established. Collaborative session control may then be transferred from mobile device 270 to the fixed line 280 or the projector 290. For example, the collaborative session 250 may then permit the fixed line 280 and/or the projector 290 to maintain control over the voice component 220 and/or the video component 230. In one embodiment, the collaborative session 240 may be terminated after collaborative session control and/or control over the media flow is transferred to the collaborative session 250.

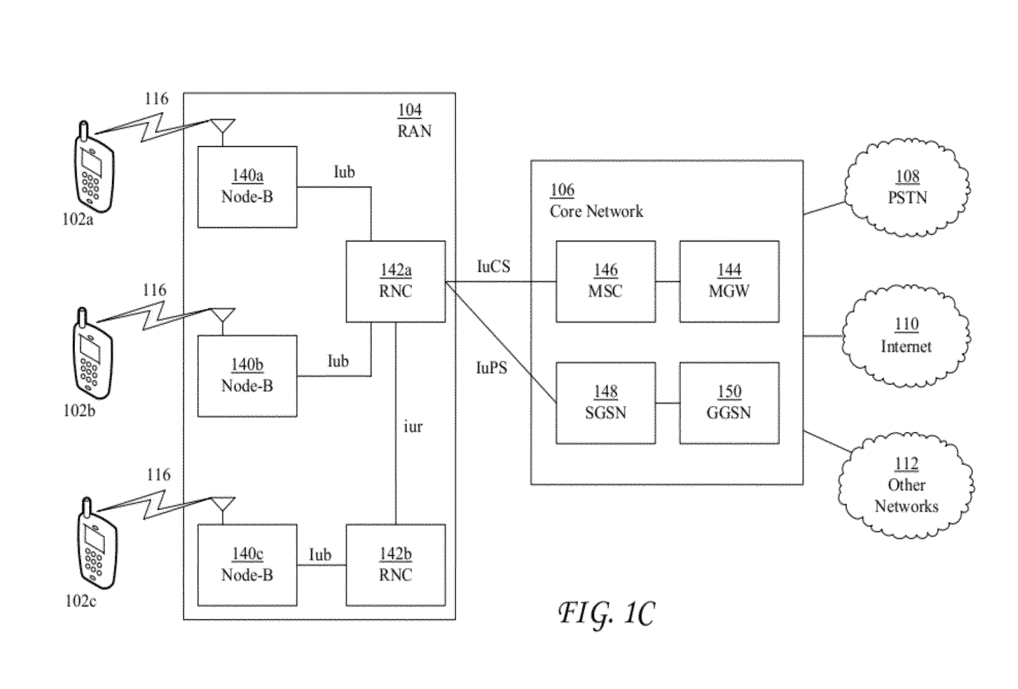

FIG. 3 illustrates an architecture view of an inter-UE communication flow transfer in an IP packet switched network. In FIG. 3, a correspondent node (CN) 215 may communicate with a mobile node (MN) such as mobile node #1 (MN1) 225 in communication session. A correspondent node such as CN 215 may be a peer node with which a mobile node such as MN1 225 or MN2 235 is communicating. The CN may include a mobile node and/or a stationary node. For example, a CN may include a WTRU 102 as described in FIGS. 1A-1E. The communication session may include one or more communication flows. Communication flows may include, but are not limited to, application flows, data flows, media flows, multimedia flows, etc. For example, an application flow may be communicated between CN 215 and MN1 225 via an application interface 285a.

A communication session may be transferred from one mobile node to another mobile node, for example, from MN1 225 to mobile node #2 (MN2) 235. For example, when a communication session is transferred, the communication flow associated with the communication session may be transferred along with the communication session. For example, the application flow between MN1 225 and CN 215 may be transferred from MN1 225 to mobile node #2 (MN2) 235 such that the application flow may be communicated between CN 215 and MN2 235 via an application interface 285b. The application flow may be communicated via an application interface protocol that may be specific to an application or general to one or more applications.

MN1 225 may be associated with a home agent such as home agent #1 (HA1) 245. As shown, MN1 225 may communicate with HA1 245 via a mobile IP interface 275a. A home agent may be a router on a mobile node's home link or home network, for example. The MN1 225 may register its current care-of address with the HA1 245. When the MN1 225 is away from the home link, the HA1 245 may intercept packets on the home link destined to the MN1 225 home address. The HA1 245 may encapsulate information included in the packets, and may send the information to the MN1 225 registered care-of address. The MN2 235 may be associated with a home agent such as home agent #2 (HA2) 255. The MN2 235 may register its current care-of address with the HA2 255. As shown, MN2 235 may communicate with HA2 255 via a mobile IP interface 275b. When the MN2 235 is away from its home link, the HA2 255 may intercept packets on the home link destined to the MN2 235 home address. The HA2 255 may encapsulate information included in the packets, and may send the information to the MN2 235 registered care-of address. For purposes of example, and not limitation, the home agents such as HA1 245 and HA2 255 may communicate with the mobile nodes such as MN1 225 and MN2 235 via a mobile IP protocol such as MIPv6.

In an embodiment, HA1 245 and HA2 255 may be connected to a session central continuity function node (SCCF) such as SCCF 265. The SCCF 265 may register mobile nodes capable of supporting IUT features in a mobile protocol, such as MIPv6, environment. The SCCF 265 may control the transfer of the communication flows between these mobile nodes such as MN1 225 and MN2 235. SCCF 265 may update the connection between the mobile nodes such as MN1 225 and MN2 235 and the CN 215. An SCCF node may include a network device that may include a processor such as processor 118 as described in relation to FIG. 1B, a transceiver such as transceiver 120 as described in relation to FIG. 1B, a memory such as non-removable memory 106 and removable memory 132 as described in relation to FIG. 1B.

SCCF 265 may communicate with home agents associated with mobile nodes. SCCF 265 may communicate with HA1 245 and HA2 255 via a message based protocol such as SCCa. For example, SCCF 265 may communicate with HA1 245 and HA2 255 via SCCa interfaces 295a and 295b. SCCF 265 may communicate with CN 215 via a message based protocol such as SCCa. For example, the SCCF 265 may communicate with the CN 215 via an SCCa interface 295c. Communication protocol SCCa may be based on an existing message based protocol that may carry a number of messages that instruct how media flow communication may be set-up. For purposes of example, SCCa may be based on a Session Description Protocol (SDP) transported over a session initiation protocol (SIP). SDP may include a format for describing streaming media initialization parameters. The Session Initiation Protocol (SIP) is a signaling protocol that may be used for controlling multimedia communication sessions such as voice and video calls over Internet Protocol (IP). SCCa may include a protocol that may carry a number of messages for instructing how communication flows may be set up.

MIP may used to enable Inter UE Transfer (IUT). For example, information related to an IUT transfer may be transported via MIP between a mobile node and a home agent. For example, information related to an IUT transfer may be transported via MIP between MN1 225 and HA1 245, and between MN2 235 and HA2 255. A communication flow transfer may be originated by a user action, e.g., on MN1 225. An IUT transfer request may be sent from MN1 225 to MN2 235 through HA1 245, SCCF 265 and HA2 255. MN2 235 may then accept or reject the IUT transfer request. Should the IUT request be accepted, MN2 235 may launch and set up the proper application based on information and/or data provided in the IUT transfer request. The MN2 235 may send a response to SCCF 265. The SCCF 265 may inform the correspondent node (CN) of the IUT transfer. Upon reception, the CN may transfer the communication flow to MN2. The CN may report the transfer to the SCCF 265. The SCCF 265 may send an IUT response to MN1 225, for example, through HA1 245. MN1 may perform the appropriate cleanup. Cleanup may include MN1 225 stopping the communication flow that may have been transferred to MN2 235.

In an embodiment, some or all of the nodes illustrated in FIG. 3 such as CN 215, SCCF 265, HA1 245, HA2 255, MN1 225, and/or MN2 235 may be MIP based nodes. In addition, other embodiments that include more nodes, such as a second or more SCCF or CN nodes, or a third or more home agent and mobile node are contemplated.

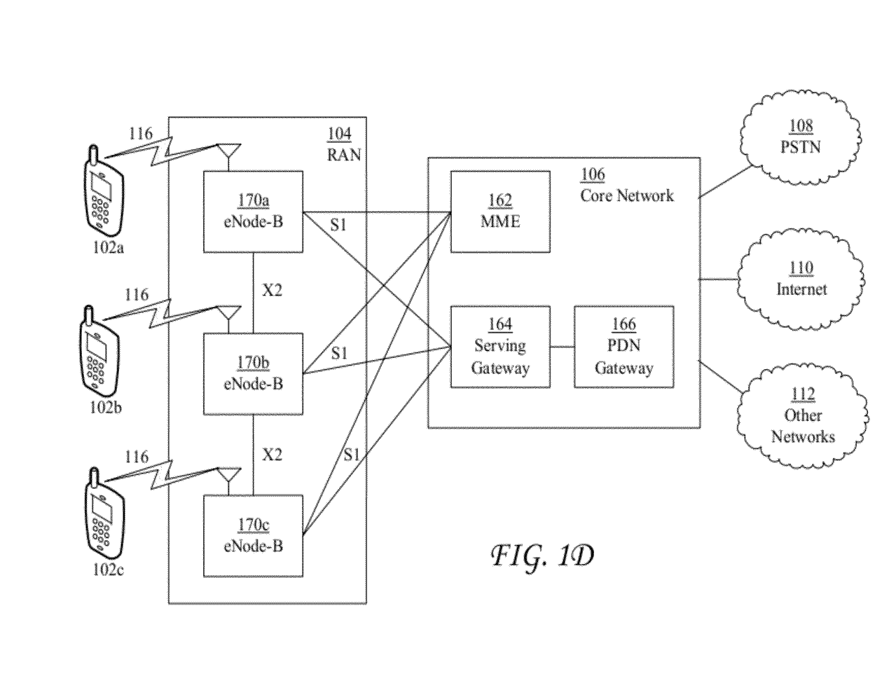

FIG. 4A illustrates an embodiment of a communication session transfer between the two mobile nodes such as MN1 225 and MN2 235. At 302, MN1 225 may perform MIP registration with HA1 245 such that MN1 225 may be registered with SCCF 265, for example, via session continuity control (SCC) registration. At 304, MN2 235 may perform MIP registration with HA2 255 such that MN2 235 may be registered with SCCF 265, for example, via session continuity control (SCC) registration. At 306, media flow may be established between CN 215 and MN1 225.

A home agent such as HA1 245 or HA2 255 may register mobile nodes such as MN1 225 or MN2 235 with the SCCF 265 at a MIP registration time. For example MN1 225 may be registered with the SCCF 265 at a first MIP binding update. In an embodiment, a mobile node may be in the home network, and the respective home agent may not register mobile nodes with the SCCF 265. The SCCF 265 and the respective home agent such as HA1 245 or HA2 255 may not require a mobile node to be registered to accept IUT requests or to send responses.

At 308, a communication session such that may include a media flow may occur between MN1 225 and CN 215. In an embodiment, the media flow, which may be referred to as “flow” or “F” herein, may pass though HA1 245.

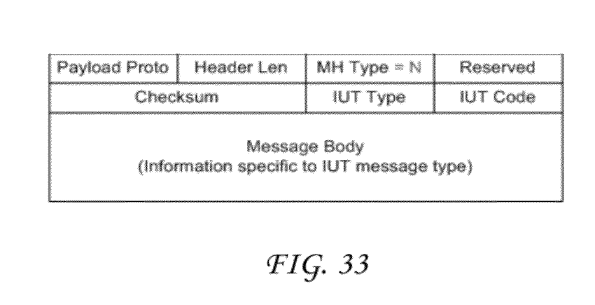

FIG. 34 illustrates an example a communication flow transfer. As shown, at 3420, an indication to transfer the communication flow from a first node to a second node may be received. The first node may include, for example, a mobile node such as MN1 225 as described above with respect to FIGS. 3, 4A and 4B. The second node may include, for example, a mobile node such as MN2 235 as described above with respect to FIGS. 3, 4A and 4B. For example, the indication to transfer the communication flow may be received via a processor of a mobile node, such as the processor 118 described above with respect to FIG. 1B, and/or via a transceiver of a mobile node, such as the transceiver 120 described above with respect to FIG. 1B.

For example, turning back to FIG. 4A, at 310, a user of MN1 225 may trigger a communication session transfer to MN2 235. The target MN, flow IDs, and/or flow attributes, among others may be identified.

Turning back to FIG. 34, at 3430, a communication flow transfer request associated with the communication flow may be sent via mobile internet protocol. For example, the communication flow transfer request associated with the communication flow may be sent via a processor of a mobile node, such as the processor 118 described above with respect to FIG. 1B, and/or via a transceiver of a mobile node, such as the transceiver 120 described above with respect to FIG. 1B.

Turning back to FIG. 4A, at 312, MN1 225 may communicate to HA1 245 an IUT request over MIP. The IUT request may include an IUT descriptor. The IUT descriptor may include an originating MN ID, a target MN ID, and flow IDs, and/or other parameters that may be provided by MN1 225. The IUT request may be transmitted via MIP. For example, the IUT request may be sent using new a MIP message, or reusing an existing MIP message with the IUT descriptor added.

The IUT descriptor may include fields that may identify a flow or set of flows, the application the flow relates to, bookmark information, and session transfer information. Session transfer information may include current and new end points identifiers and associated session continuity information. The IUT descriptor may include information such as, but not limited to, source end point information, destination end point information, remote end point information, application level information. Source end point information may include, but not limited to, home address of a source node such as the home address of MN1 225, and session continuity parameters such as quality of service (QoS) and codec information. Session continuity parameters may be provided by the source node such as MN1 225. Session continuity parameters may be included in the IUT descriptor of an IUT request message. Session continuity parameters may be included in the IUT descriptor of an IUT response message.

Destination end point information may include, but is not limited to, home address of a destination or target node such as MN2 235, and/or session continuity parameters. Session continuity parameters may be provided by destination or target node such as MN2 235. Remote end point information, may include, but is not limited to, an address associated with the remote end point such as the IP address of CN 215. Application level information may include, but is not limited to, application name or media type information, bookmark information, and/or application parameters such as port numbers.

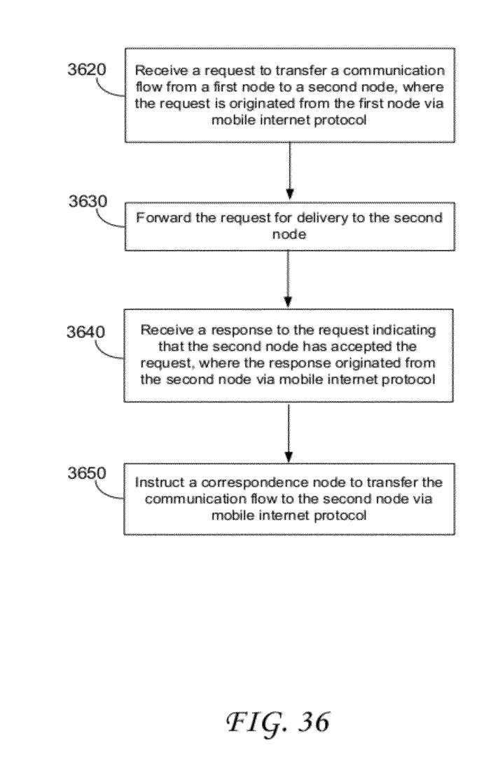

FIG. 36 illustrates an example a communication flow transfer. As shown, at 3620, a request to transfer a communication flow from a first node to a second node may be received. The request may be originated from the first node via mobile internet protocol. For example, the indication to transfer the communication flow may be received via a processor of a network device, such as the processor 118 described above with respect to FIG. 1B, and/or via a transceiver of a network device, such as the transceiver 120 described above with respect to FIG. 1B. The first node may include, for example, a mobile node such as MN1 225 as described above with respect to FIGS. 3, 4A and 4B. The second node may include, for example, a mobile node such as MN2 235 as described above with respect to FIGS. 3, 4A and 4B.

For example, turning back to FIG. 4A, at 314, the HA1 245 may receive the IUT request from MN1 225 and may communicate the IUT request to SCCF 265. In an embodiment, the communication to the SCCF may be based on a target MN, such as MN2 235 for example. The IUT request that HA1 245 communicates to SCCF 265 may include the IUT descriptor. The IUT request from the HA1 245 to SCCF 265 may be transported using a number of signaling protocols, for example Session Initiation Protocol (SIP). For example, a SIP REFER method may be used. SCCF 265 may determine the target node to transfer the communication to based on the IUT descriptor in the IUT request. For example, SCCF 265 may determine the target node is MN2 235 based on the destination end point information in the IUT descriptor.

At 316, SCCF 265 may determine that MN2 235 is registered. SCCF 265 may determine that MN2 235 may use HA2 255 as a home agent. For example, MNs may be registered in SCCF 265 by their respective HA upon MIP registration. Registration may take place, for example, upon MIP first binding update. In an embodiment, based on the registration information, SCCF 265 may determine whether a particular MN is registered and/or identify the home agent associated with a particular MN. In an embodiment, SCCF 265 may determine whether a particular MN is registered via a presence mechanism such as Extensible Messaging and Presence Protocol (XMPP). In an embodiment, SCCF 265 may identify the home agent associated with a particular MN via pre-configuration. For example, SCCF 265 may determine a specific IP address range that may be handled by HA2 255 based on pre-configuration information. SCCF 265 may authorize the service and may send a request for approval from MN2 235.

As shown in FIG. 36, at 3630, the request may be forwarded for delivery to the second node. For example, the indication to transfer the communication flow may be received via a processor of the network device, such as the processor 118 described above with respect to FIG. 1B, and/or via a transceiver of the network device, such as the transceiver 120 described above with respect to FIG. 1B.

For example, turning back to FIG. 4A, at 318, SCCF 265 may communicate the IUT request to HA2 255. The IUT request may include the originating MN ID, the target MN ID, Flow IDs, and flows attributes, among other parameters that may have been provided by MN1 225. In an embodiment, the IUT request may include a forward of the message from 314.

At 320, HA2 255 may process the IUT request and may communicate the IUT request over MIP to MN2 235 for approval. The IUT request may be communicated to MN2 235 via an MIP message that may be dedicated to IUT. The IUT request may include the originating node such as MN1 225, flow IDs, and flow attributes, among other parameters. The IUT request may be a forward of the message from 318, with information encapsulated in an MIP message.

As shown in FIG. 36, at 3640, a response to the request may be received. For example, the response may indicate that the second node has accepted the request. The response may be originated from the second node via mobile internet protocol. For example, the response to the request may be received via a processor of the network device, such as the processor 118 described above with respect to FIG. 1B, and/or via a transceiver of the network device, such as the transceiver 120 described above with respect to FIG. 1B.

For example, turning back to FIG. 4A, at 322, MN2 235 may accept the IUT request. In an embodiment, an input from a user that may indicate the approval of IUT request may be received. MN2 235 may prepare an application to resume the transferred session. The IUT descriptor may be used to determine which application to use, and how to set up the application to assume the communication session. For example, based on the IUT descriptor sent by MN1 225, MN2 235 may start an application associated with the session, and may set the application to a state such that MN2 235 may resume the flow from CN 215. MN2 235 may reject the IUT request at 322. For example, the IUT response may indicate that the target MN has rejected the IUT request.

At 324, MN2 235 may communicate an IUT response over MIP to HA2. For example, the IUT response over MIP may indicate that MN2 235 has accepted the transfer request. The IUT response may include an IUT descriptor. The IUT descriptor may be created based on the IUT descriptor received from MN1 225. For example, MN2 may modify the received descriptor to match the new conditions. For example, QoS or codec information may be modified to match the new mobile node capabilities. For example, MN2 235 may update the descriptor to add session continuity parameters associated with MN2 235, such as supported codecs.

At 326, HA2 may communicate the IUT response to SCCF 265. In an embodiment, if the target node such as MN2 235 cannot be reached, the IUT request may fail. The HA associated with the target node, such as HA2 255 may reply with an IUT response indicating a failure. SCCF 265 may receive the IUT response from the HA2.

As shown in FIG. 36, at 3650, a correspondence node may be instructed to transfer the communication flow to the second node. For example, the correspondence node may be instructed via a processor of the network device, such as the processor 118 described above with respect to FIG. 1B, and/or via a transceiver of the network device, such as the transceiver 120 described above with respect to FIG. 1B.

For example, turning back to FIG. 4A, at 328, SCCF 265 may send an IUT request to the CN 215. At 330, CN 215 may accept the transfer from MN1 225 to MN2 235. CN 215 may close a connection to MN1 225 and close the session related to the transferred media flow. CN 215 may open a new session to MN2 235, and may resume the transferred media flow where it stopped or at a given point. CN 215 may determine the new end point of the session based on the IUT descriptor. For example, CN 215 may use the home IP address for the MN2 235 as the new end point for the flow. CN 215 may use the information in the IUT descriptor to match the flow to transfer. CN 215 may determine how to perform session continuity such as which codec to use, for example, based on the IUT descriptor. CN 215 may use the information provided by MN2 235 in the IUT descriptor to adapt the flow to MN2 235. In an embodiment, an application-specific setup at 336 may be initiated in lieu of or in addition to 330. At 337, the transferred media flow between MN2 235 and CN 215 may be underway, following either 330 and/or 336. In an embodiment, application data may pass though HA2 255 as the media flows between MN2 235 and CN 215.

At 338, the CN 215 may communicate an IUT response message to SCCF 265. The IUT response message may indicate that the IUT has been completed. At 340, SCCF 265 may communicate the IUT response message to HA1 245. At 342, HA1 245 may communicate the IUT response message over MIP to MN1 225. The IUT response message may be a forward of the message from 340 with information encapsulated in accordance with MIP protocol. For example, the IUT response message may be communicated to MN1 225 in an MIP message specific to IUT. In an embodiment, an existing MIP message may be reused to hold this information. At 344, MN1 225 may perform cleanup of the transferred session. For example, MN1 225 may stop the communication session on its side.

FIG. 4B depicts a different illustration of the embodiment described in FIG. 3.

IUT over MIP messages such as IUT request messages, IUT response messages and IUT complete messages may hold IUT related information. In an embodiment, an existing MIP message may be reused to hold this information. In an embodiment, an MIP header may hold IUT related information.

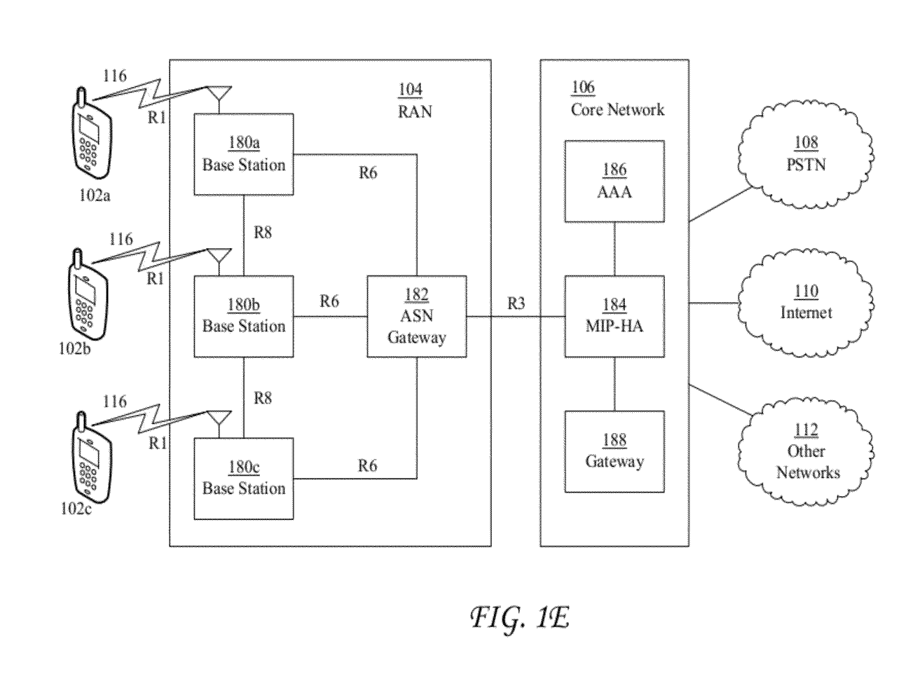

FIG. 5 illustrates an example embodiment of mobile internet protocol header. As shown, a MIP header may include fields such as payload proto, header length such as Header Len, mobility header type such as MH Type, a reserved field, checksum, IUT type, IUT code, and/or IUT descriptor. For example, the payload proto field may include a one-bit field, the Header Len field may include a one-bit field, the MH Type field may include a one-bit field, the reserved field may include a one-bit field, the checksum field may include a two-bit field, the IUT type field may include a one-bit field, and the IUT code field may include a one-bit field.

In an example IUT message, the value associated with the MH type field may be set to a value that may indicate that the MIP message is a communication flow transfer message. For example, a value of N may indicate that the header is an MIP IUT header. In an embodiment, the IUT type field may include one or more values that may indicate the type of the flow transfer message. For example, the IUT type field may include values such as 0 for indicating that the message being a flow transfer request message, 1 for indicating that the message being a flow transfer response message, and 2 for indicating that the message being a flow transfer complete message, for example. Other values for the IUT type field may be reserved for other usage. For example, other values may be used to match other methods used in various IUT scenarios, such as an SIP UPDATE or SIP OPTIONS used in IUT related scenarios in IMS. The IUT code field may be used to return IUT response codes such as, but not limited to, SUCCESS and FAILURE. For example, various failure codes may be used to provide information associated with a failure.

The IUT descriptor may include an encoding of the IUT descriptor values. For example, SDP could be used. In another example, another encoding method would be a binary (e.g. type-length-value (TLV) based) encoding. As described above, the IUT descriptor may include an address of the source node such as the home address of MN1 225, an address of the target node such as the home address of MN2 235, an address of a correspondence node such as the IP address of CN 215, session continuity parameters, and/or application specific parameters.

In an embodiment, the IUT descriptor may be encoded differently when transported over different interfaces. For example, when transported over an SCCa interface such as SCCa interfaces 295a-c shown in FIG. 3, the IUT descriptor may be encoded in SDP format and transported over SIP. For example, when transported over an MIP interface such as MIP interfaces 275a and 275b, encoding for MIP messages carrying IUT information may be encoded in accordance with MIP protocol. Although other mobile protocols are contemplated, in FIG. 5, an IPv6 header dedicated to MIP is illustrated. When an IP packet is received with such a header, the information contained in the header may be processed by an MIP stack.

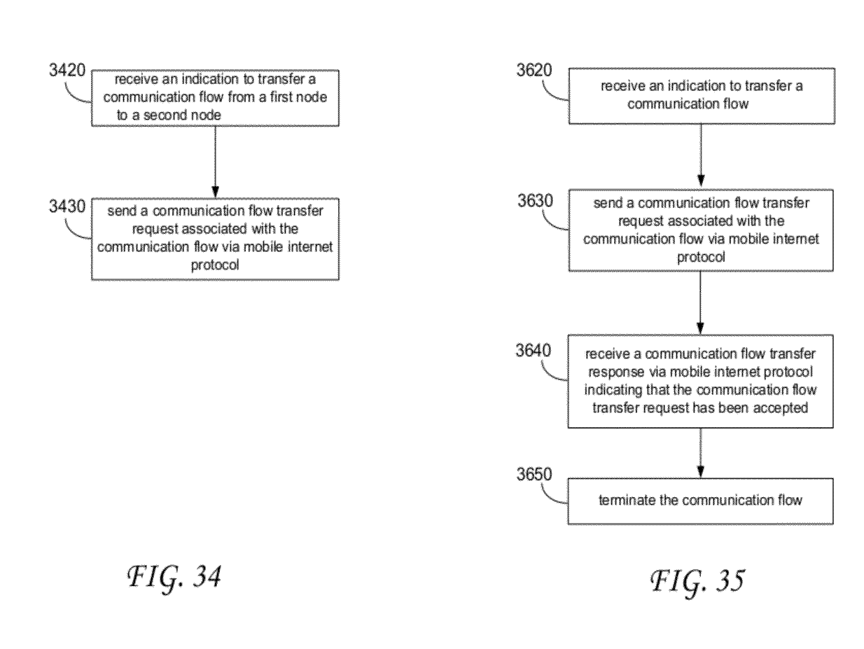

FIG. 35 illustrates an example a communication flow transfer. As shown, at 3520, an indication to transfer the communication flow from a first node to a second node may be received. The first node may include, for example, a mobile node such as MN1 225 as described above with respect to FIGS. 3, 4A and 4B. The second node may include, for example, a mobile node such as MN2 235 as described above with respect to FIGS. 3, 4A and 4B.

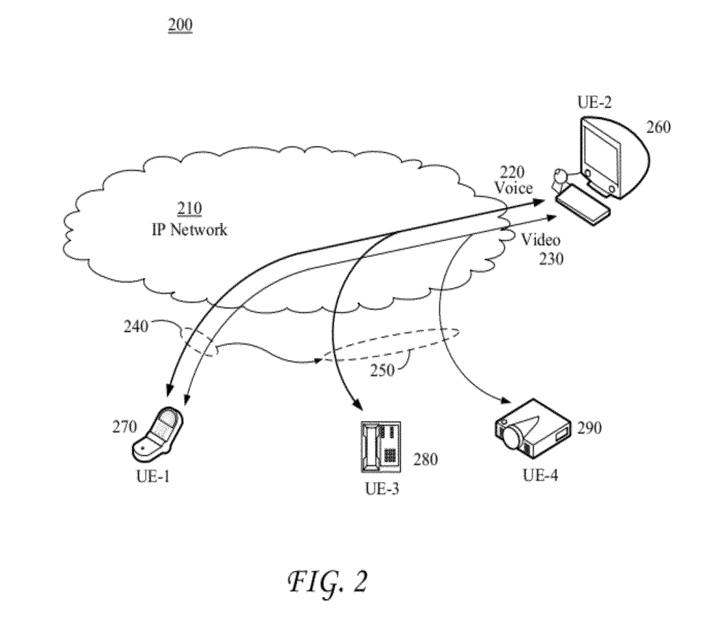

FIG. 6 illustrates an example embodiment of a mobile node that may request a communication flow transfer using a mobile internet protocol. A mobile node, for example MN1 225 described above with respect to FIGS. 4A and 4B, may initiate a transfer of a communication session such as a media session. The communication session may include a communication flow such as a media flow.

As shown in FIG. 6, mobile node or mobile device 650 may include an originating or source node, such as MN1 225 as described above with respect to FIGS. 3, 4A and 4B. As shown, the mobile node 650 may include an application module 620, an IUT service module 630, and an MIP stack module 640. The modules 620-640 may be hardware and/or software implemented. In an embodiment, the modules 620-640 may be stored on non-removable memory 106 and/or removable memory 132 as described above with respect to FIG. 1B. In an embodiment, the modules 620-640 may be executed by processor 118 as described above with respect to FIG. 1B.

As shown in FIG. 6, at 602, the IUT service 630 may register to the MIP stack 640. For example, registration may be performed when the IUT service 630 starts, which may be when the host starts up. Registration may be performed via a background program to provide IUT service 630 to multiple applications. At 604, applications such as the application 620 may register to the IUT service 630 at application startup.

For example, at 606, an indication from a user to transfer a communication flow may be received at IUT service 630. The application 620 may pass session information such as the IUT descriptor to the IUT service 630. In an embodiment, an IUT target address may be received from the IUT service. For example, the indication from the user may include the IUT target address.

For example, the indication to transfer the communication flow may be received via a processor of a mobile node, such as the processor 118 described above with respect to FIG. 1B, and/or via a transceiver of a mobile node, such as the transceiver 120 described above with respect to FIG. 1B.

Turning back to FIG. 35, at 3530, a communication flow transfer request associated with the communication flow may be sent via mobile internet protocol. For example, the communication flow transfer request associated with the communication flow may be sent via a processor of a mobile node, such as the processor 118 described above with respect to FIG. 1B, and/or via a transceiver of a mobile node, such as the transceiver 120 described above with respect to FIG. 1B.

As shown in FIG. 6, at 608, the IUT service 630 may call an MIP stack API to invoke the IUT request procedure. The MIP stack API may include an interface between the IUT service 630 and the MIP stack 640. The IUT service 630 and/or the MIP stack 640 may generate an IUT request, such as an IUT request message as described with respect to FIGS. 4A and 4B. For example, the IUT request may include an MIP message. The MIP stack 640 may encapsulate information associated with the IUT in a mobile internet protocol header described with respect to FIG. 5. At 610, the IUT request may be sent to a home agent associated with the mobile node 650, for example, for delivery to SCCF 265 and/or the target node.

As shown in FIG. 35, at 3540, a communication flow transfer response may be received via mobile internet protocol. The response may indicate that the communication flow transfer request has been accepted. For example, a communication flow transfer response may be received via a processor of a mobile node, such as the processor 118 described above with respect to FIG. 1B, and/or via a transceiver of a mobile node, such as the transceiver 120 described above with respect to FIG. 1B.

For example, turning back to FIG. 6, at 612, an IUT response may be received at the MIP stack 640. The IUT response may include an MIP message. For example, an MIP message indicating that the IUT has been completed may be received from a home agent associated with the mobile node 650. The MIP stack 640 may parse the mobile internet protocol header of the IUT response for information associated with the IUT. For example, information associated the IUT may include information indicative of failure or success of operation. At 614, information associated the IUT may be passed to the IUT service 630.

As shown in FIG. 35, at 3550, the communication flow at the WTRU may be terminated. For example, the communication flow may be terminated via a processor of a mobile node, such as the processor 118 described above with respect to FIG. 1B.

Turning back to FIG. 6, at 616, the IUT service 630 may send the information associated the IUT to the application 620. Cleanup of the transferred flow may be performed. For example, upon receipt of information indicating that the IUT has been successfully completed, application 620 may stop listening to media.

In an embodiment, 606 and 608 shown in FIG. 6 may be part of 310 as described in FIGS. 4A and 4B. 610 shown in FIG. 6 may be part of 312 of FIGS. 4A and 4B. 612 shown in FIG. 6 may be part of 342 of FIGS. 4A and 4B. 614 and 616 shown in FIG. 6 may be part of 344 of FIGS. 4A and 4B.

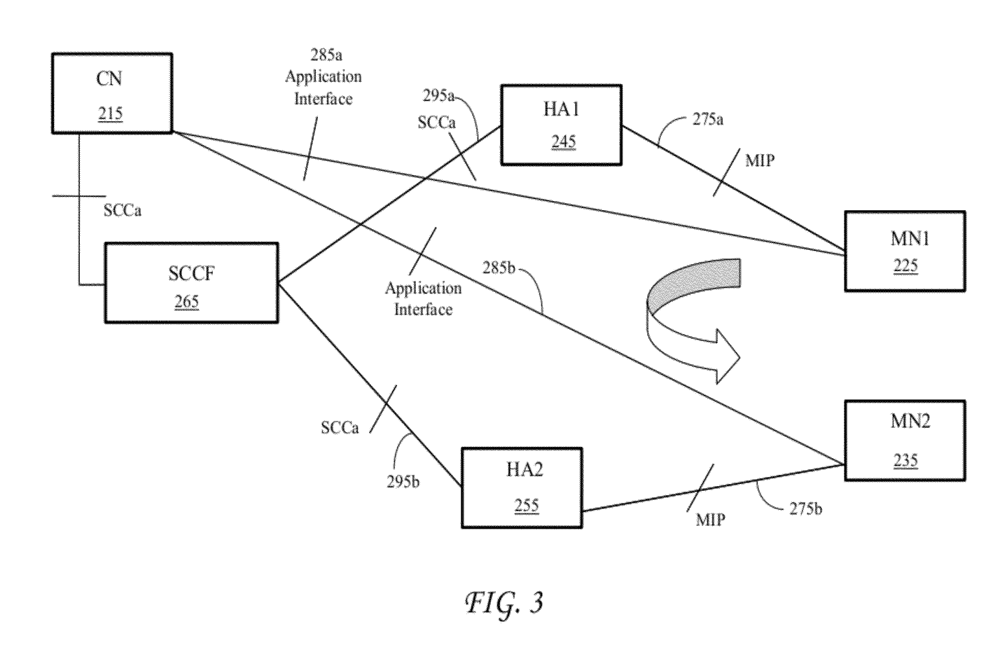

FIG. 7 illustrates an example embodiment of a mobile node that may respond to a communication flow transfer request using a mobile internet protocol. A mobile node, for example MN2 235 of FIGS. 4A and 4B, may receive a transfer of a communication session. For example, a target node such as MN2 235 may receive IUT request messages and send IUT response messages.

As shown in FIG. 7, mobile node or mobile device 750 may include an destination or target node, such as MN2 235 as described above with respect to FIGS. 3, 4A and 4B. As shown, the mobile node 750 may include an application module 720, an IUT service module 730, and an MIP stack module 740. The modules 720-740 may be hardware and/or software implemented.

As shown in FIG. 7, at 702, the IUT service 730 may register to the MIP stack 740. At 704, the MIP stack may receive an IUT request, for example from an associated home agent such as HA2 255. As described above, the IUT request may include an MIP message. At 706, the MIP stack 740 may parse the mobile internet protocol header of the IUT response for information associated with the IUT request. The MIP stack 740 may pass the information associated with IUT request to the IUT service 730. At 708, the IUT service 730 may spawn a proper application such as application 720. The IUT service 730 may pass the IUT descriptor information to the application 720 such that the application 720 may resume the transferred communication flow at the proper position. In an embodiment, the application 720 may select the proper codec/QoS requirements for the flow, and may set this information in the IUT descriptor.

At 710, when the application 720 may be ready to receive the communication flow, the application 720 may create an IUT response. For example, the application 720 may invoke an IUT response API associated with the IUT service 730, and may pass the IUT descriptor to the IUT service in the process. The IUT service 730 and/or the MIP stack 740 may generate an IUT response, such as an IUT response message as described with respect to FIGS. 4A and 4B. At 712, the IUT service 730 may forward the call to the MIP stack 740. The MIP stack may encapsulate information associated with the IUT response such as the IUT descriptor in a mobile internet protocol header described with respect to FIG. 5. At 714, the MIP stack may send the IUT response to an associated HA, for example HA2 255, for delivery to SCCF 265, CN 215, and/or MN1 225.

In an embodiment, 704 of FIG. 7 may be considered part of 320 as described in FIGS. 4A and 4B. 706-712 of FIG. 7 may be considered part of 322 of FIGS. 4A and 4B. 714 of FIG. 7 may be considered part of 324 of FIGS. 4A and 4B.

The communication protocols and messages in the previously disclosed embodiments may be implemented in alternative embodiments that may include more or less nodes than those described in FIGS. 4A and 4B.

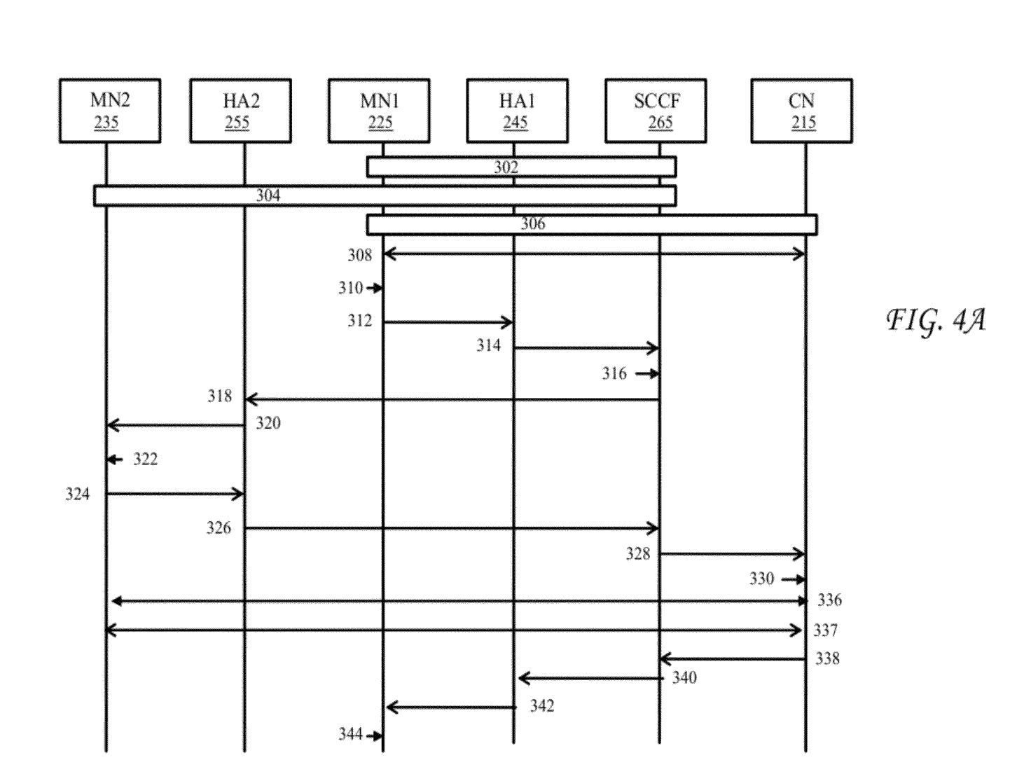

FIGS. 8-14 illustrate example network architecture diagrams supporting communication flow transfer among mobile nodes using mobile internet protocol.

As shown in FIG. 8, MN1 may be associated with a home agent such as HA1. MN1 may communicate with HA1 using MIP protocol. MN2 may be associated with a home agent such as HA2. MN2 may communicate with HA2 using MIP protocol. As shown in FIG. 8, a single SCCF may be associated with both HA1 and HA2. For example, the SCCF may communicate with both HA1 and HA2 via a message based protocol such as SCCa.

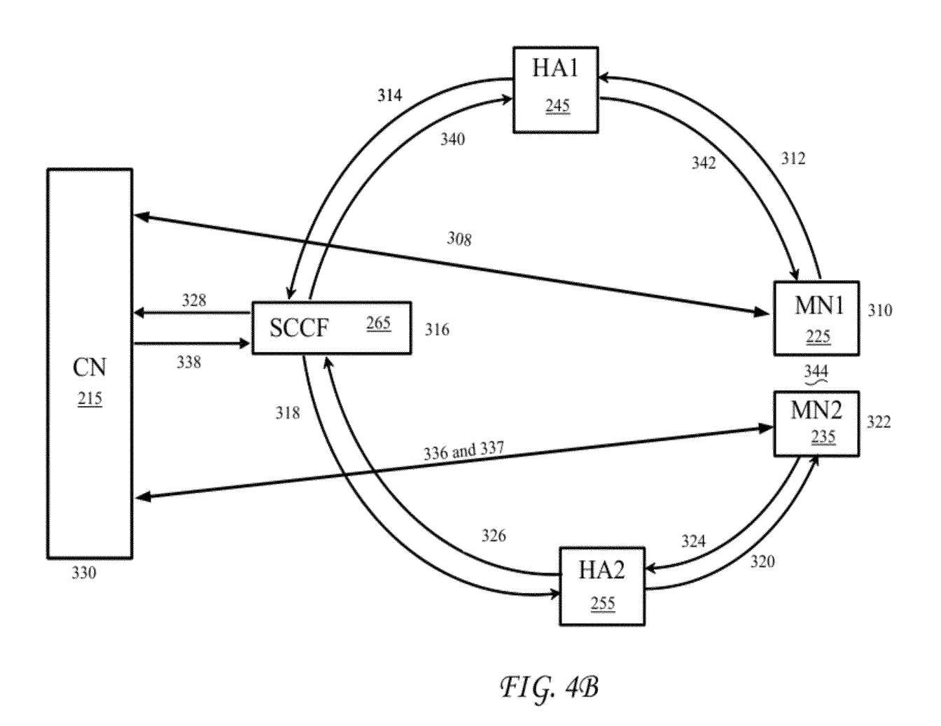

As shown in FIG. 9, multiple SCCF Nodes, such as SCCF1 and SCCF2 may be used for load and deployment in larger networks, or for other reasons. As shown, SCCF1 may be associated with HA1, and SCCF2 may be associated with HA2. SCCF1 and SCCF2 may have an interface via a message-based protocol such as SCCa. In an embodiment, IUT requests and responses may be passed via the SCCa interface amongst the multiple SCCF Nodes. For example, HA1 and HA2 may exchange messages via SCCF1 and SCCF2, and the SCCa interface between SCCF1 and SCCF2. For example, SCCF1 and SCCF2 may collaborate with each other using SCCa.

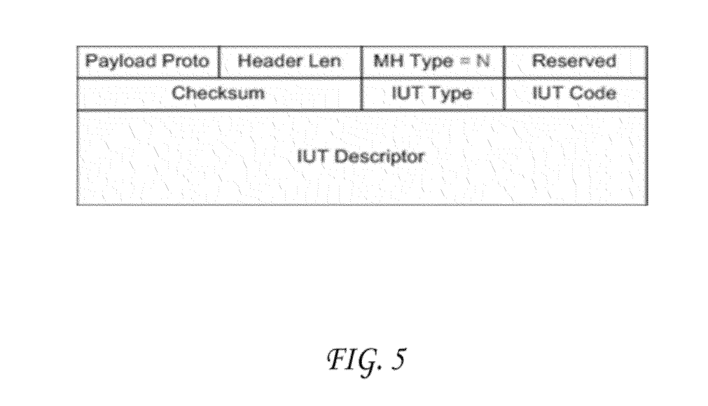

As shown in FIG. 10, an SCCF and an HA may be collocated. SCCF1 and HA1 may be collocated, for example, at a single network node. SCCF2 and HA2 may be collocated, for example, at a single network node. The SCCF-HA interface may be performed using function calls. In an embodiment, the SCCF/HA-MN1 interface may transport IUT over MIP messages. The SCCF/HA-MN1 interface may transport regular MIP messages.

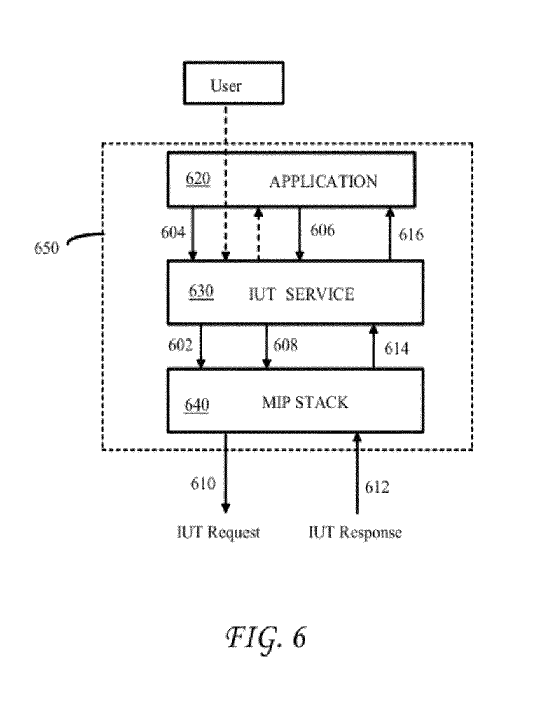

As shown in FIG. 11, mobile nodes such as MN1 and MN2 may directly communicate with a single SCCF. As shown, an MIP interface may be used directly between the SCCF and MN1/MN2 via MIP. In an embodiment, the SCCF may directly send and/or receive the IUT over MIP messages to and/or from MN1 and MN2. Home agents may not be involved in the IUT exchange, but may be part of the normal IP traffic routing. The interface between a SCCF and a mobile node may be used only for IUT over MIP messages.

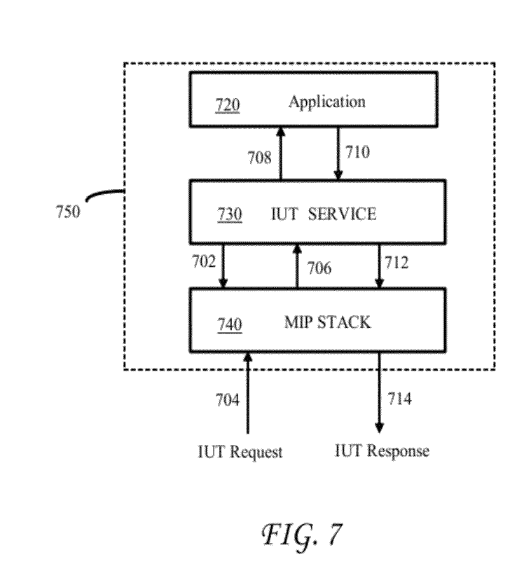

As shown in FIG. 12, multiple SCCF nodes such as SCCF1 and SCCF2 may collaborate with each other using SCCa. Each of the SCCF nodes may directly communicate with their respective mobile nodes such as MN1 and MN2 via MIP for IUT requests. In an embodiment, home agents may not be involved in the IUT exchange, but may be part of the normal IP traffic routing.

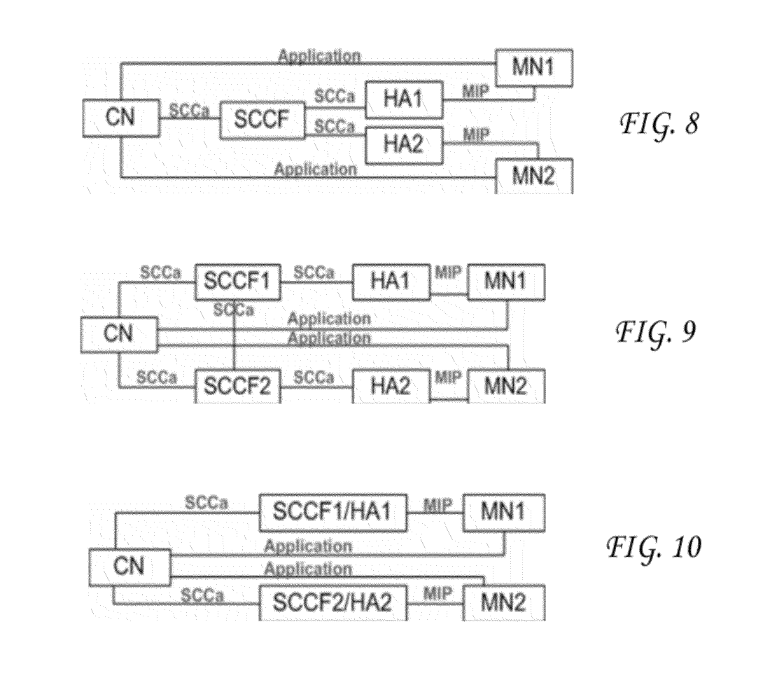

As shown in FIG. 13, a single HA may be associated with multiple mobile nodes such as MN1 and MN2. For example, MN1 and MN2 may belong to a group of mobile nodes associated with the same HA. In an embodiment, IUT over MIP messages between MN1 and MN2 may be transmitted via the HA without involving an SCCF.

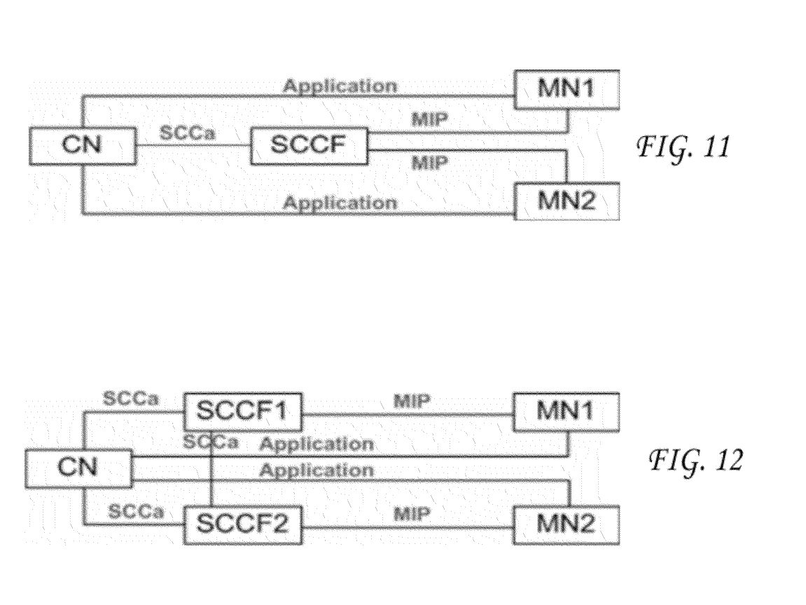

As shown in FIG. 14, a single HA may be associated with multiple mobile nodes such as MN1 and MN2. For example, MN1 and MN2 may belong to a group of mobile nodes associated with the same HA. The HA may be collocated with an SCCF at a network node.

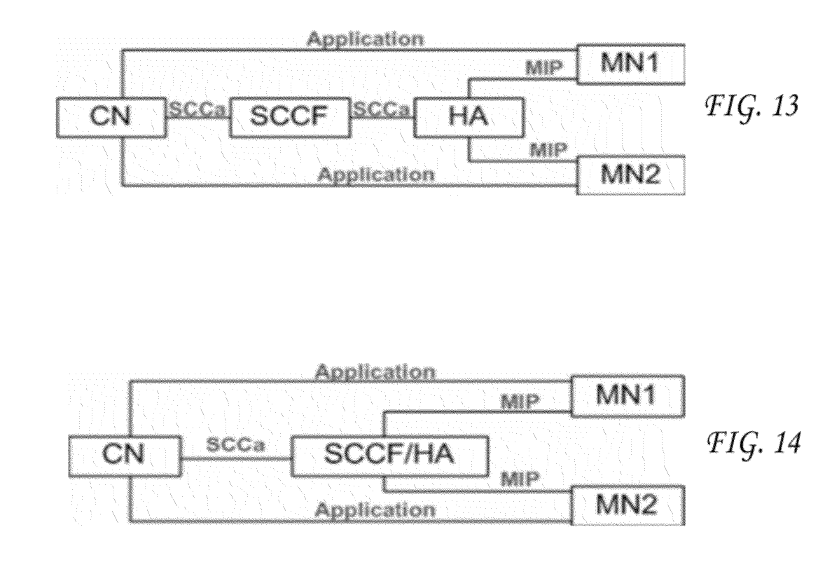

FIG. 15 illustrates an example embodiment of a system 1500 for providing a collaborative session for MIP-based IUT transfers. For example, communication flows may be transferred from one terminal, such as the mobile device 1570, to a second terminal, such as the computer 1560. For example, a mobile device user may decided to transfer the voice component, such as voice component 1520, of a media session to a fixed phone, such as the fixed phone 1580, and the video component, such as the video component 1530, of the same media session to a video projection, such as the projector 1590. According to an example embodiment, the system 1500 may include the IP network 1510. The IP network 1510 may be a network such as a Public Land Mobile Network (“PLMN”), an IMS network, corporate intranet, a Fixed-End System (“FES”), the public Internet, or the like. It should be noted that network elements such as routers, gateways switches, and/or the like, may be included within the IP network 1510.

As illustrated in FIG. 15, the IP network 1510 may be in operative communication with one or more mobile nodes, wireless transmit/receive units (WTRU), or UEs, such as the mobile device 1570. The network 1510 may also be in operative communication with the fixed phone 1580, the projector 1590, the computer 1560, or the like. The configurations and the communications between the IP network 1510 and the mobile devices or WTRUs is provided for illustrative purposes, and as such, the communications between the specified WTRUs may be between different elements and/or through additional elements as well as different signaling/commands may be used.

A user associated with the mobile device 1570 may establish a multimedia flow with a remote party associated with the computer 1560. The multimedia flow may include one or more media components, such as the voice component 1520 and/or the video component 1530. The fixed line 1580 and/or the projector 1590 may be in operative connection with the IP network 1510, the mobile device 1570 and/or the computer 1560. The fixed line 1580 and the projector 1590 may belong to one or more IMS subscriptions that differ from the IMS subscription of the mobile device 1570. Additionally, the fixed line 1580 and the projector 1590 may belong to one or more network operators that differ from the network operator of the mobile device 1570.

A communication flow such as the multimedia flow between the fixed line 1580 and/or the projector 1590 may be established with the remote party, such as the computer 1560. The media flow may be received at the fixed line 1580 and/or the projector 1590. In an embodiment, the media flow may be broken into components, where each component may then be received by the fixed line 1580 and/or the projector 1590. For example, the voice component 1520 of media flow may be transferred to the fixed line 1580 and the video component of the media flow may be transferred to the projector 1590. When the media flow is received at the fixed line 1580 and/or the projector 1590, a collaborative session 1550 may then be established. Collaborative session control may then be transferred from mobile device 1570 to the fixed line 1580 or the projector 1590. For example, the collaborative session 1550 may then permit the fixed line 1580 and/or the projector 290 to maintain control over the voice component 1520 and/or the video component 1530. In one embodiment, the collaborative session 1540 may be terminated after collaborative session control and/or control over the media flow is transferred to the collaborative session 1550.

As shown in FIG. 15, a collaborative session such as an IUT control session 1585 may be associated with a controller 1565 and one or more controlees 1575. As shown, an SCCF such as SCCF 1555 may create and maintain the IUT control session 1585, for example, via interfaces 1535a-d. For example, the SCCF 1555 may allocate the role of controller and controlee to one or more network nodes. The controller 1565, the controlee(s) 1575, and the SCCF 1555 may communicate with each other via the IP network 1510. A controller of an IUT control session may include one or more network nodes, such mobile nodes, fixed phones, projectors and/or computers. A controlee of an IUT control session may include one or more network nodes, such mobile nodes, fixed phones, projectors and/or computers.

A collaborative session may be associated with an SCCF, a controller, one or more controlees and a session ID. For example, the collaborative session may be identified via a unique identifier such as a session ID.

The SCCF may maintain information associated with one or more collaborative sessions. For example, The SCCF may maintain information that may include, but not limited to, the nodes involved in the collaborative session (e.g., MN1 and MN2), home agents relating to the nodes, identification of the controller(s), identification of the controlee(s), authorization and/or policy information, and/or information to retrieve authorization and/or policy. The SCCF may maintain a description of flows associated with the collaborative session. The description of the flows may be used, for example, to implement a fallback transfer. The SCCF may retrieve information associated with a collaborative session using its respective session ID.

The controller may maintain description of flows associated with the collaborative session. For example, the controller may maintain information on end point(s), port(s), and/or associated application(s) related to the collaborative session. The controller may retrieve information associated with a collaborative session using its respective session ID.

The controlee(s) may maintain description of flows associated with the collaborative session that may be terminated on the controlee. A controlee may retrieve information associated with a collaborative session using its respective session ID.

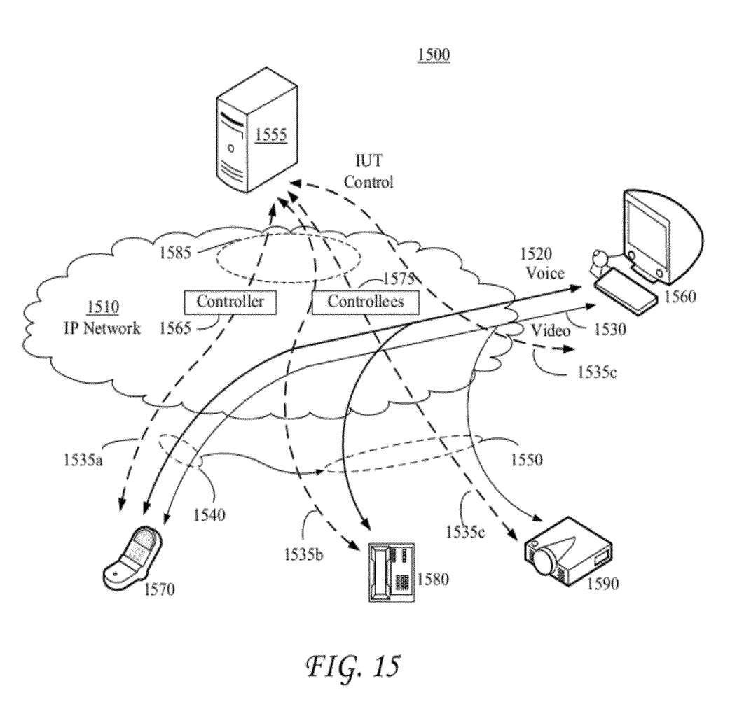

FIGS. 16-32 illustrate example collaborative session actions. Components shown in FIGS. 16-32 such as CN, SCCF, HA1, HA2, MN1, MN2, may include their corresponding components as described with respect to FIG. 3.

FIG. 16 illustrates an exemplary embodiment demonstrating creation of a collaborative session. FIG. 16 illustrates communications and/or actions that may take place as part of the creation of the collaborative session. As shown in FIG. 16, MN1 may perform MIP registration via HA1 such that MN1 may be registered with the SCCF, for example, via session continuity control (SCC) registration. MN2 may perform MIP registration via HA2 such that MN2 235 may be registered with the SCCF, for example, via session continuity control (SCC) registration. Communication flow may be established between CN and MN1.

As shown in FIG. 16, a user of MN1 may trigger flow transfer to MN2. MN1 may communicate to SCCF an IUT request over MIP via HA1. An IUT request over MIP, for example, may include an IUT request MIP message, which will be described in more detail below. The IUT request may include a unique identifier. The unique identifier may include a set of fields that may be concatenated to uniquely identify the collaboration session. For example, the unique identifier may include information that may identify MN1. In an embodiment, the unique identifier may be used as the session ID associated with the collaboration session.

As shown in FIG. 16, SCCF may determine that MN2 is registered. The SCCF may determine that MN2 may use HA2 as a home agent. The SCCF may create a collaborative session.

SCCF may communicate the IUT request to HA2. HA2 may process the IUT request and may communicate the IUT request over MIP to MN2 for approval. In an embodiment, an input from a user that may indicate the approval of IUT request may be received. The IUT request may be communicated to MN2 via an MIP message. MN2 may accept the IUT request and may prepare an application to resume the transferred session. MN2 may communicate an IUT response over MIP. The IUT descriptor may be created based on the IUT descriptor received from MN1. For example, the IUT descriptor may have been modified by MN2 to match the new conditions. For example, QoS or codec information may be modified to match the new mobile node capabilities.

SCCF may communicate the IUT request to the CN. CN may accept the transfer from MN1 to MN2. CN may close a connection to MN1 and close the session related to the transferred media flow. CN may open a new session to MN2, and may resume the transferred media flow where it has stopped or at a given point. For example, an application specific dialog may tear down the current or old flow and may establish a new flow. In an embodiment, the setup and teardown processes of a collaborative session may be initiated from a client side such as MN1 and MN2, and the CN may not need to be contacted to trigger the IUT transfer. As shown, the SCCF may allocate MN1 as the controller of the collaborative session, and MN2 as the controlee of the collaborative session.

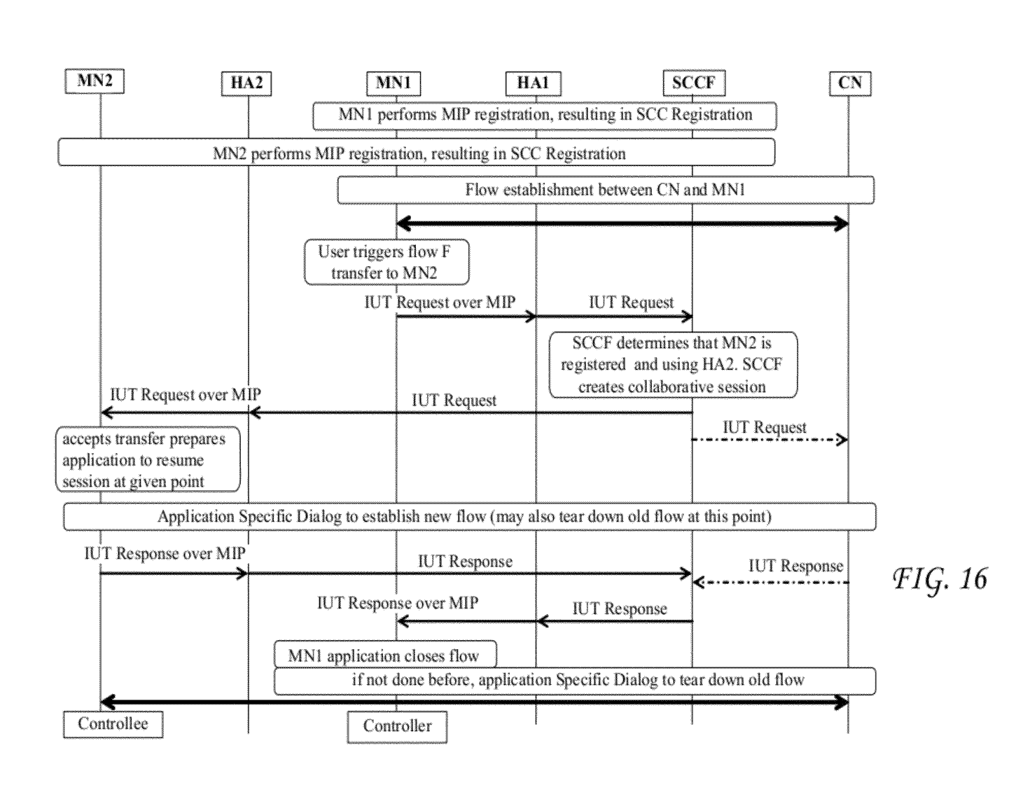

FIG. 17 illustrates an exemplary embodiment of a collaborative session action where a controller initiates flow transfer from the controller to a controllee. The SCCF may have allocated MN1 as the controller of the collaborative session, and MN2 as the controlee of the collaborative session. There may be a communication flow such as Video1 flow between MN2 and CN. There may be one or more communication flows such as Audio1, Audio2 flows between MN1 and CN. For example, MN1 may initiate a transfer of a communication flow such as Audio1 flow to MN2.

As shown in FIG. 17, a user of MN1 may trigger flow transfer to MN2. MN1 may send an IUT request over MIP to HA1. HA1 may parse the MIP message from MN1 and may forward the information associated with IUT request to SCCF. The IUT request may include a unique identifier such as a session ID that may uniquely identify the collaboration session. SCCF may retrieve information associated with the collaborative session involving MN1 and MN2 based on the session ID. SCCF may authorize transfer. SCCF may communicate the IUT request to HA2. HA2 may process the IUT request and may communicate the IUT request over MIP to MN2 for approval. MN2 may accept the IUT transfer. For example, an application specific dialog may tear down the current or old flow and may establish a new flow.

As shown in FIG. 17, MN2 may communicate an IUT response over MIP to SCCF via HA2. An IUT response over MIP, for example, may include an IUT response MIP message that will be described in more detail below. As described above, SCCF may maintain information associated with collaborative sessions. SCCF may update information associated with the collaborative session with the new communication flow. For example, SCCF may update information associated with the collaborative session to reflect that the Audio1 flow is between MN2 and CN. SCCF may forward the IUT response over MIP to MN1 via HA1. Upon receipt of the IUT response, MN1 may terminate the communication flow between MN1 and CN. For the example, the application on MN1 that facilitates the communication flow between MN1 and CN may close the flow. For example, an application specific dialog may tear down the current or old flow. As shown, upon completion of the flow transfer, Video1 flow and Audio1 flow may be between MN2 and CN, and Audio2 flow may be between MN1 and CN.

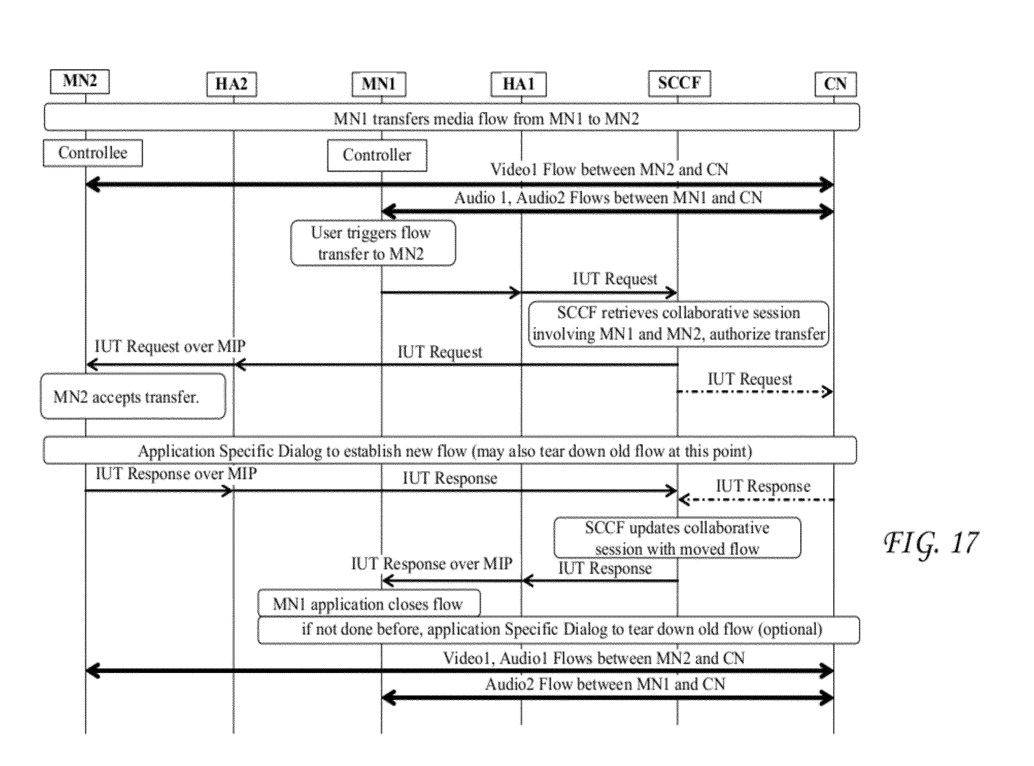

FIG. 18 illustrates an exemplary embodiment of a collaborative session action where a controller UE initiates flow transfer from a controllee to the controller. As shown, MN1 may be the controller of a collaborative session, and MN2 may be the controlee of the collaborative session. There may be one or more communication flows such as Video1 and Audio1 flows between MN2 and CN. There may be one or more communication flows such as Audio2 flow between MN1 and CN. For example, MN1 may initiate a transfer of a communication flow such as Audio1 flow from MN2 to MN1.

As shown in FIG. 18, a user of MN1 may trigger flow transfer from MN2 to MN1. MN1 may send an IUT request over MIP to HA1. HA1 may parse the MIP message from MN1 and may forward the information associated with IUT request to SCCF. The IUT request may include a unique identifier such as a session ID that may uniquely identify the collaboration session. SCCF may retrieve information associated with the collaborative session involving MN1 and MN2 based on the session ID. SCCF may authorize transfer.

SCCF may communicate the IUT request to the CN. CN may accept the transfer from MN2 to MN1. CN may close a connection to MN2 and close the session related to the transferred media flow. CN may open a new session to MN1, and may resume the transferred media flow where it stopped or at a given point. For example, an application specific dialog may tear down the current or old flow and may establish a new flow. In an embodiment, the setup and teardown processes of a collaborative session may be initiated from a client side such as MN1 and MN2, and the CN may not need to be contacted to complete the IUT transfer.

As shown in FIG. 18, SCCF may create an IUT response indicating the approval of the IUT request. SCCF may communicate an IUT response to HA1. HA1 may process the IUT response and may communicate the IUT response to MN1 over MIP. An application specific dialog may tear down the current or old flow and may establish a new flow.

As shown in FIG. 18, MN1 may send an IUT transfer indication over MIP to HA1. The IUT transfer Indication over MIP may include an IUT transfer indication MIP message that will be described in more detail below. HA1 may parse IUT transfer indication over MIP and the forward an IUT transfer indication to SCCF. As described above, SCCF may maintain information associated with collaborative sessions. SCCF may update information associated with the collaborative session with the new communication flow. For example, SCCF may update information associated with the collaborative session to reflect that the Audio1 flow is between MN1 and CN. SCCF may send the IUT transfer indication to HA2. HA2 may encapsulate the information related to the IUT transfer indication in an MIP message such as an IUT transfer indication over MIP, and may send the IUT transfer indication over MIP to MN2.

As shown in FIG. 18, upon receipt of the IUT transfer indication, MN2 may terminate the communication flow between MN2 and CN. For the example, the application on MN2 that facilitates the communication flow between MN2 and CN may close the flow. MN2 may send an IUT transfer indication acknowledgement over MIP to HA2. An IUT transfer indication acknowledgement over MIP may include an IUT Transfer Indication Ack MIP message, which will be described in more detail below. HA2 may parse IUT transfer indication acknowledgement over MIP, and may forward information associated with IUT transfer indication acknowledgement to SCCF. SCCF may forward the received information associated with IUT transfer indication acknowledgement to HA1. HA1 may encapsulate the received information associated with IUT transfer indication acknowledgement in an IUT transfer indication acknowledgement over MIP and send the MIP message to MN1. As shown, upon completion of the flow transfer, Video1 flow may be between MN2 and CN, and Audio1 and Audio2 flows may be between MN1 and CN. In other words, Audio1 has been transferred from MN2 to MN1.

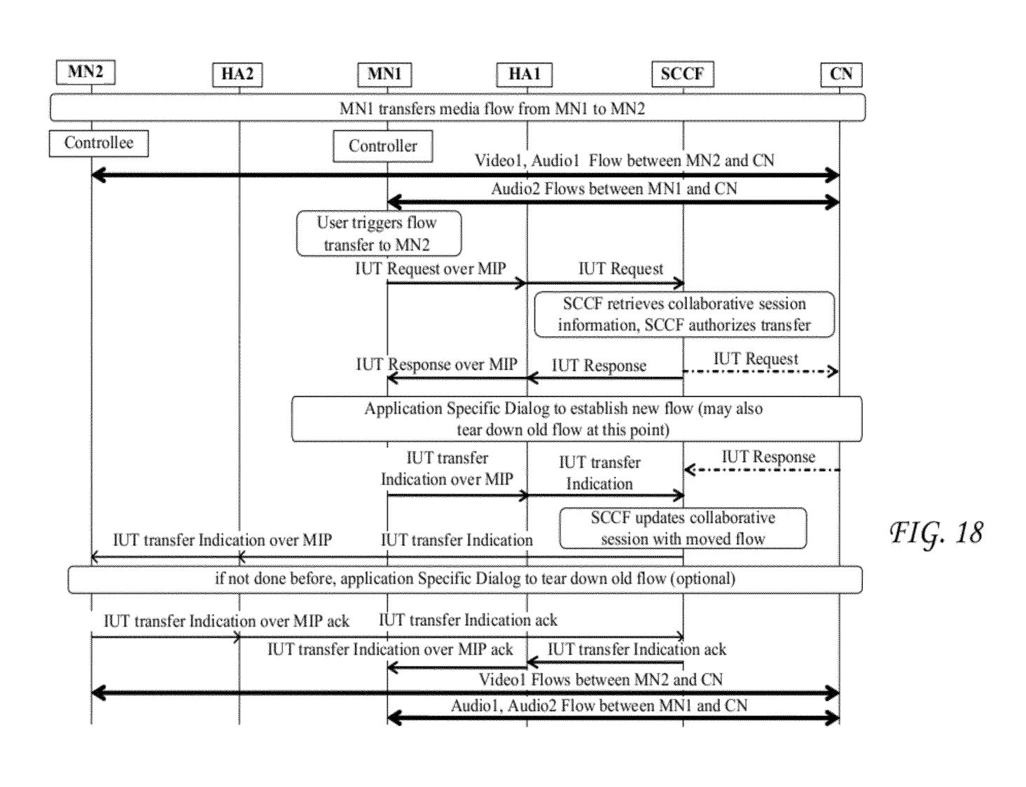

FIG. 19 illustrates an exemplary embodiment of a collaborative session action where a controller initiates flow transfer from a controllee to another controllee. As shown, MN1 may be the controller of a collaborative session, and MN2 and MN3 may be the controlees of the collaborative session. There may be a communication flow such as Video1 flow between MN2 and CN. There may be a communication flow such as Audio1 between MN1 and CN. There may be a communication flows such as Audio2 between MN3 and CN.

As shown in FIG. 19, a user of MN1 may trigger flow transfer from MN3 to MN2. MN1 may send an IUT request over MIP to HA1. HA1 may parse the MIP message from MN1 and may forward the information associated with IUT request to SCCF. The IUT request may include a unique identifier such as a session ID that may uniquely identify the collaboration session. SCCF may retrieve information associated with the collaborative session involving MN1 and MN2 based on the session ID. SCCF may authorize transfer.

SCCF may communicate the IUT request to the CN. CN may accept the transfer from MN3 to MN2. CN may close a connection to MN3 and close the session related to the transferred media flow. CN may open a new session to MN2, and may resume the transferred media flow where it stopped or at a given point. For example, an application specific dialog may tear down the current or old flow and may establish a new flow. In an embodiment, the setup and teardown processes of a collaborative session may be initiated from a client side such as MN1, MN2 and MN3, and the CN may not need to be contacted to complete the IUT transfer.

As shown in FIG. 19, SCCF may communicate the IUT request to HA2. HA2 may process the IUT request and may communicate the IUT request over MIP to MN2 for approval. MN2 may accept the IUT transfer. For example, an application specific dialog may tear down the current or old flow and may establish a new flow.

As shown in FIG. 19, MN2 may communicate an IUT response over MIP to SCCF via HA2. HA2 may parse IUT response over MIP and the forward an IUT response to SCCF. As described above, SCCF may maintain information associated with collaborative sessions. SCCF may update information associated with the collaborative session with the new communication flow. For example, SCCF may update information associated with the collaborative session to reflect that the Audio2 flow is between MN2 and CN.

As shown in FIG. 19, SCCF may communicate the IUT request to HA3. HA3 may process the IUT request and may communicate the IUT request over MIP to MN3. MN3 may terminate the communication flow between MN3 and CN. For the example, the application on MN3 that facilitates the communication flow between MN3 and CN may close the flow. For example, an application specific dialog between MN3 and CN may tear down the current or old flow.

As shown in FIG. 19, MN3 may communicate an IUT response over MIP to SCCF via HA3. HA3 may parse IUT response over MIP and the forward an IUT response to SCCF. SCCF may communicate the IUT response to HA1. HA1 may process the IUT response and may communicate the IUT response over MIP to MN1.

As shown in FIG. 19, upon completion of the flow transfer, Video1 and Audio2 flows may be between MN2 and CN, and Audio1 flow may be between MN1 and CN. In other words, Audio2 has been transferred from MN3 to MN2.

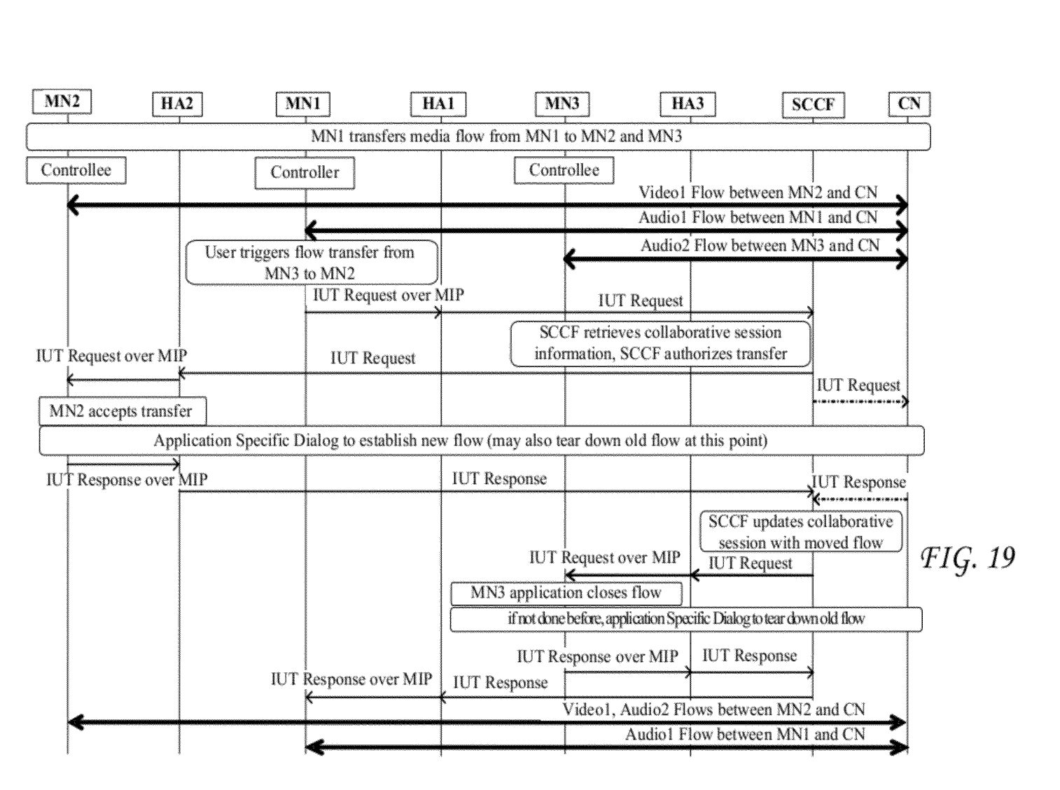

FIG. 20 illustrates an exemplary embodiment of a collaborative session action where a controller initiates a flow modification on a controllee. As shown, MN1 may be the controller of a collaborative session, and MN2 may be the controlee of the collaborative session. There may be a communication flow such as Video1 flow between MN2 and CN. There may be one or more communication flows such as Audio1 and Audio2 flows between MN1 and CN. For example, MN1 may initiate an update of a communication flow such as Video1 flow between MN2 and CN.

As shown in FIG. 20, a user of MN1 may trigger a flow update on a communication flow associated with MN2. MN1 may send a modify request over MIP to HA1. A modify request over MIP may include an IUT modify MIP message, which will be described in more detail below. HA1 may parse the MIP message from MN1 and may forward the information associated with modify request to SCCF. The modify request may include a unique identifier such as a session ID that may uniquely identify the collaboration session. SCCF may retrieve information associated with the collaborative session involving MN1 and MN2, and/or the communication flow between MN2 and CN, based on the session ID. SCCF may retrieve information associated with the HA handling MN2, for example, HA2. SCCF may authorize modification operation.

SCCF may communicate the modify request to the CN. CN may accept the modification. In an embodiment, the modification processes of a collaborative session may be initiated from a client side such as MN1 and MN2, and the CN may not need to be contacted to complete the flow modification.

As shown in FIG. 20, SCCF may communicate the modify request to HA2. HA2 may process the modify request and may communicate the modify request over MIP to MN2 for approval. An modify request over MIP may include an IUT modify response MIP message, which will be described in more detail below. MN2 may accept the modify request. For example, an application specific dialog between MN2 and CN may modify the communication flow between MN2 and CN.

As shown in FIG. 20, MN2 may create a modify response indicating the acceptance of the modify request. MN2 may send a modify response over MIP to HA2. HA2 may process modify response over MIP, and may communicate the modify response to SCCF. SCCF may forward the modify response to HA1. HA1 may process the modify response and may communicate the modify response to MN1 over MIP. As shown, upon completion of the flow modification, modified Video1 flow may be between MN2 and CN.

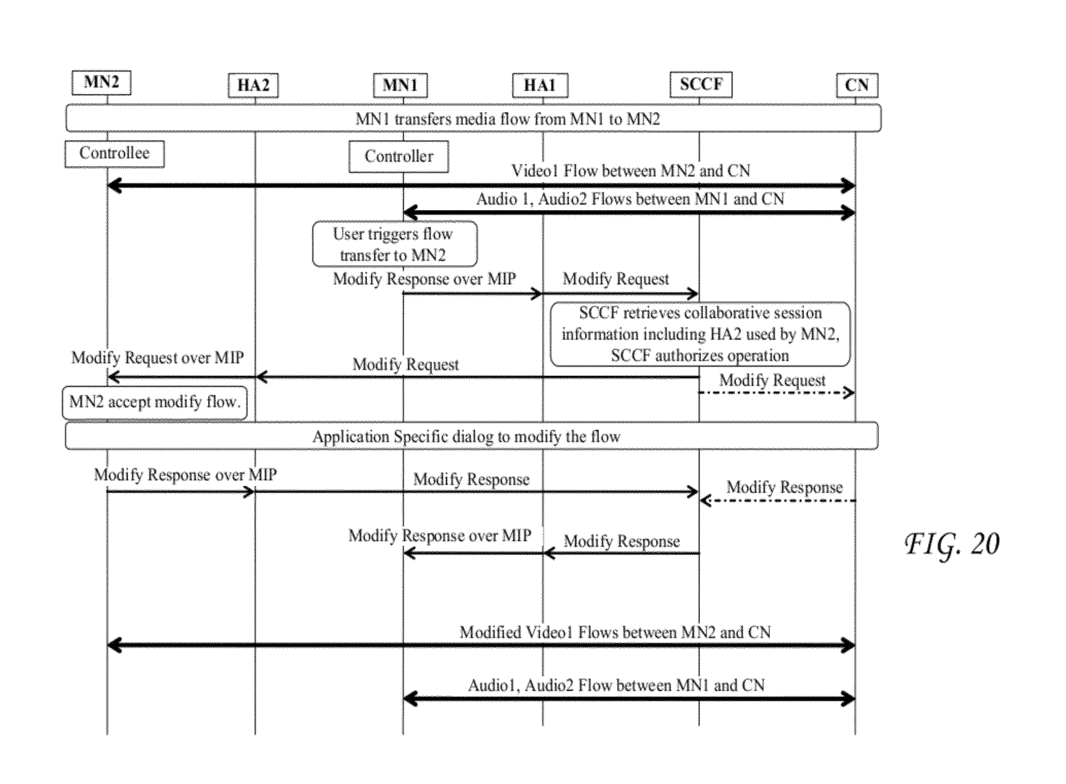

FIG. 21 illustrates an exemplary embodiment of a collaborative session action where a controller UE adds a flow to the controller UE. As shown, MN1 may be the controller of a collaborative session, and MN2 may be the controlee of the collaborative session. There may be one or more communication flows such as Video1 and Audio1 flows between MN2 and CN. There may be one or more communication flows such as Audio2 flow between MN1 and CN. For example, MN1 may add one or more communication flows, such as Audio3 flow between MN1 and CN to the collaborative session.

As shown in FIG. 21, a user of MN1 may trigger adding a communication flow on MN1. For example, an application dialog between MN1 and CN may be carried out to add the new communication flow. Audio3 flow may start between the MN1 and CN. As shown, MN1 may send an IUT indication add flow over MIP to HA1. An IUT indication add flow over MIP may include an IUT add flow MIP message, which will be described in more detail below. HA1 may parse the MIP message from MN1 and may forward the information associated with the IUT indication add flow to SCCF.

As described above, SCCF may maintain information associated with collaborative sessions. Upon receipt of the IUT indication add flow, SCCF may update information associated with the collaborative session with the new communication flow. The information associated with the collaborative session maintained at SCCF may be accessible to the nodes associated with the collaborative session. For example, if MN2 later becomes the controller of the session, MN2 may obtain the information associated with the new communication flow such that MN2 may initiate a move and/or a modification the flow.

As shown in FIG. 21, SCCF may communicate the IUT indication add flow to HA1. HA1 may process the IUT indication add flow and may communicate the IUT indication add flow over MIP to MN1. As shown, upon completion of adding a new communication flow such as Audio3 to the collaboration session, Video1 and Audio1 flows may be between MN2 and CN, and Audio2 and Audio3 flows may be between MN1 and CN.

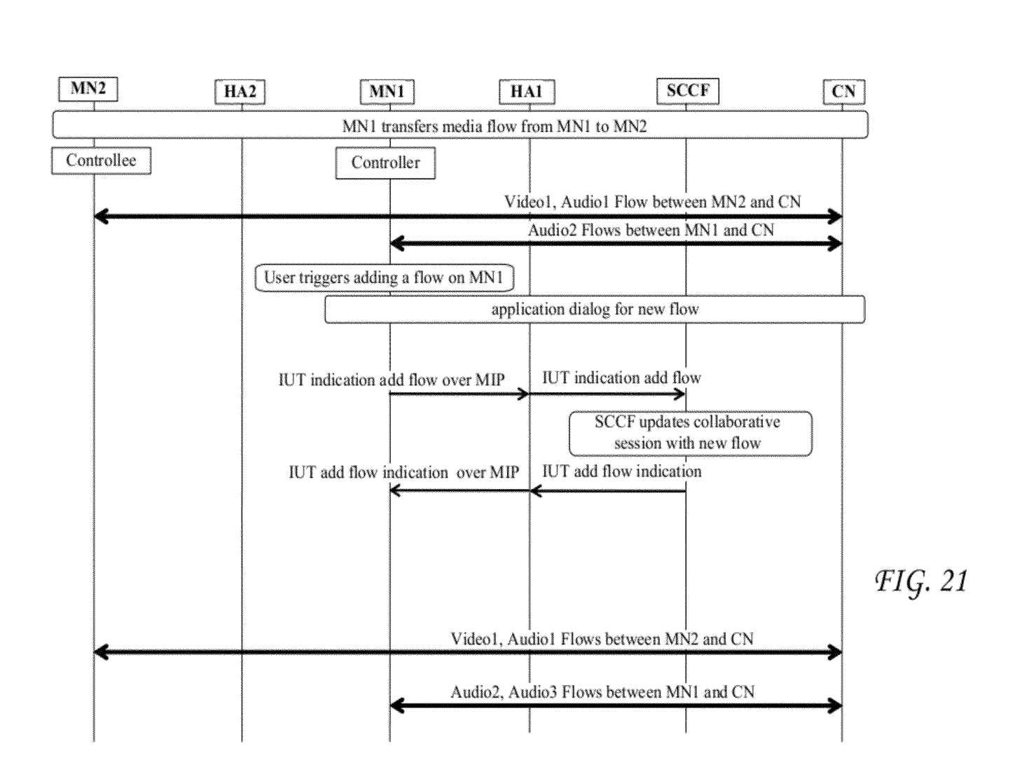

FIG. 22 illustrates an exemplary embodiment of a collaborative session action where a controller adds a flow to a controlee. As shown, MN1 may be the controller of a collaborative session, and MN2 may be the controlee of the collaborative session. There may be one or more communication flows such as Video1 flow between MN2 and CN. There may be one or more communication flows such as Audio1 flow between MN1 and CN. For example, MN1 may add one or more communication flows, such as Audio2 flow between MN2 and CN to the collaborative session.

As shown in FIG. 22, a user of MN1 may trigger adding a communication flow on MN2. MN1 may send an IUT add flow request over MIP to HA1. HA1 may parse the MIP message from MN1 and may forward the information associated with IUT add flow request to SCCF. The IUT add flow request may include a unique identifier such as a session ID that may uniquely identify the collaboration session. SCCF may retrieve information associated with the collaborative session based on the session ID. SCCF may retrieve information indicating that MN2 uses HA2 as the home agent. SCCF may authorize adding the new communication flow, such as Audio2 flow between MN2 and CN.

As shown in FIG. 22, SCCF may communicate the IUT add flow request to HA2. HA2 may process the IUT add flow request and may communicate the IUT add flow request over MIP to MN2 for approval. MN2 may accept the IUT add flow request. For example, an application dialog between MN2 and CN may be carried out to add the new communication flow. Audio2 flow may start between the MN2 and CN. As shown, MN2 may send an IUT add flow response over MIP to HA2. An IUT add flow response over MIP may include an IUT add flow response MIP message, which will be described in more detail below. HA2 may parse the MIP message from MN2 and may forward the information associated with the IUT add flow response to SCCF.

As described above, SCCF may maintain information associated with collaborative sessions. Upon receipt of the IUT indication add flow, SCCF may update information associated with the collaborative session with the new communication flow. The information associated with the collaborative session maintained at SCCF may be accessible to the nodes associated with the collaborative session. For example, if MN2 later becomes the controller of the session, MN2 may obtain the information associated with the new communication flow such that MN2 may initiate a move and/or a modification the flow.

As shown in FIG. 22, SCCF may communicate the IUT add flow response to HA1. HA1 may process the IUT add flow response and may communicate the IUT indication add flow response over MIP to MN1. Upon completion of adding a new communication flow such as Audio2 to the collaboration session, Video1 and Audio2 flows may be between MN2 and CN, and Audio1 flow may be between MN1 and CN.

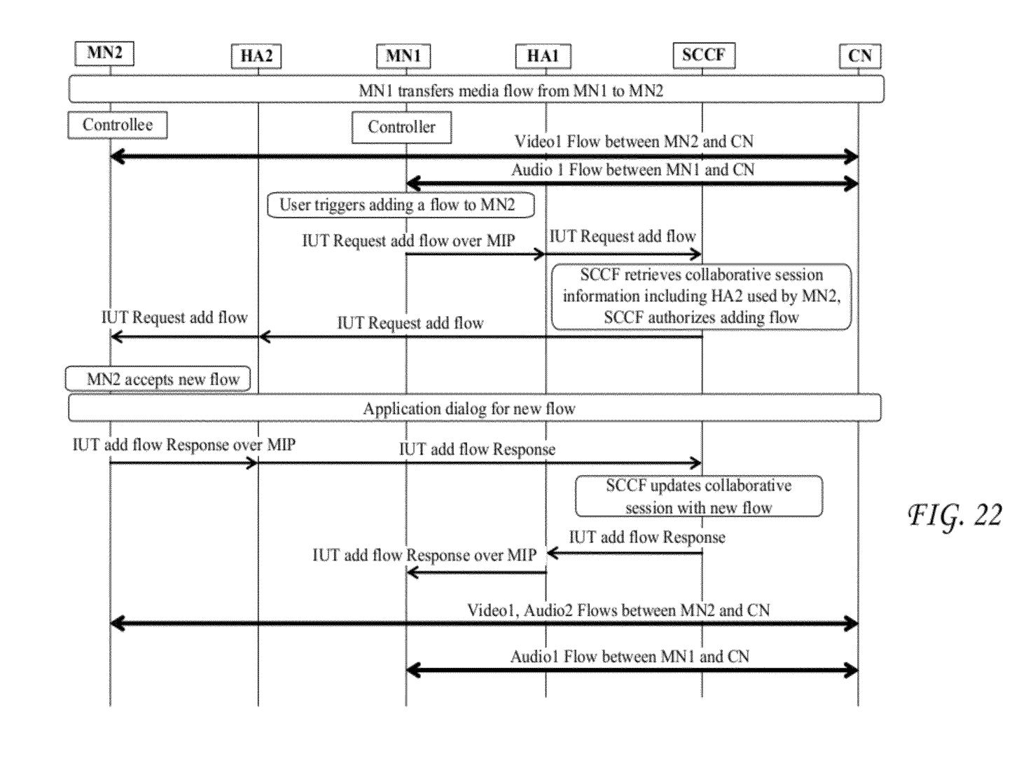

FIG. 23 illustrates an exemplary embodiment of a collaborative session action where a controller releases a flow on the controller. As shown, MN1 may be the controller of a collaborative session, and MN2 may be the controlee of the collaborative session. There may be one or more communication flows such as Video1 flow between MN2 and CN. There may be one or more communication flows such as Audio1 and Audio2 flows between MN1 and CN. For example, MN1 may release one or more communication flows, such as Audio2 flow from the collaborative session.

As shown in FIG. 23, a user of MN1 may trigger releasing a communication flow on MN1. For example, an application dialog between MN1 and CN may be carried out to release a communication flow such as Audio2 flow. As shown, MN1 may send an IUT release flow request over MIP to HA1. An IUT release flow request over MIP may include an IUT release MIP message, which will be described in more detail below. HA1 may parse the MIP message from MN1 and may forward the information associated with the IUT release flow request to SCCF.

As described above, SCCF may maintain information associated with collaborative sessions. Upon receipt of the IUT release flow request, SCCF may approve the release flow request. SCCF may update information associated with the collaborative session to reflect that the communication flow is released from the collaboration session. As shown in FIG. 23, SCCF may communicate an IUT release flow response to HA1. HA1 may process the IUT release flow response and may communicate the IUT release flow response over MIP to MN1. The IUT release flow response over MIP may include an IUT release response MIP message, which will be described in more detail below.

As shown in FIG. 23, upon completion of releasing a communication flow such as Audio2 between MN1 and CN from the collaboration session, Video1 flow may be left between MN2 and CN, and Audio1 flow may be between MN1 and CN in the collaborative session.

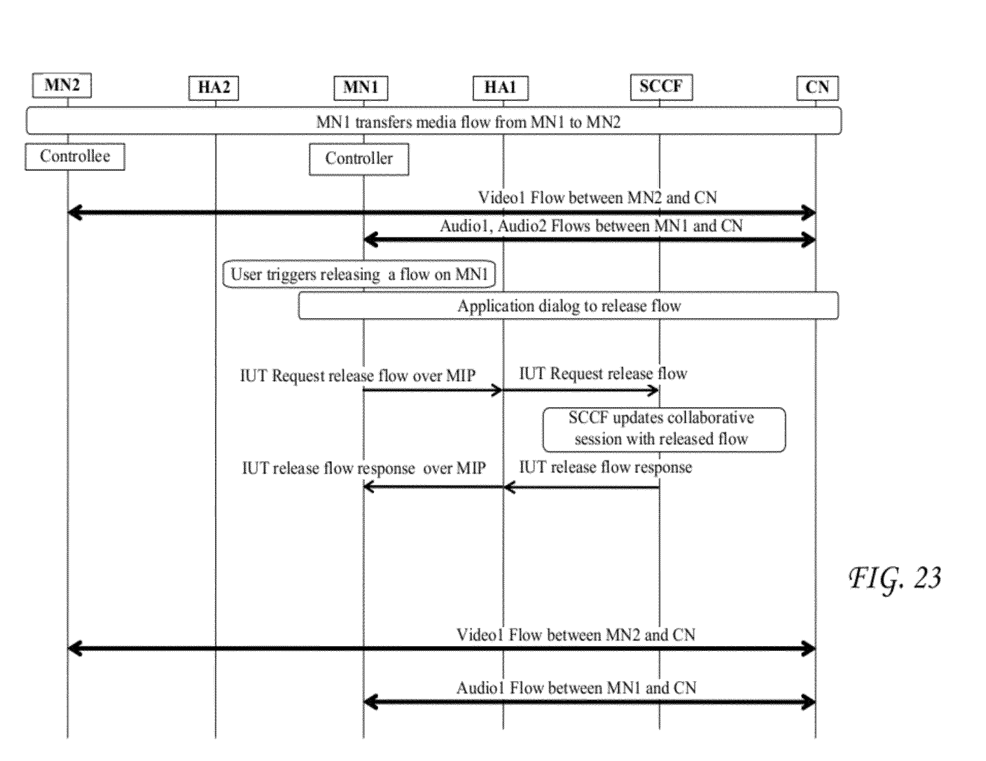

FIG. 24 illustrates an exemplary embodiment of a collaborative session action where a controller releases a flow on a controlee. As shown, MN1 may be the controller of a collaborative session, and MN2 may be the controlee of the collaborative session. There may be one or more communication flows such as Video1 and Audio2 flows between MN2 and CN. There may be one or more communication flows such as Audio1 flow between MN1 and CN. For example, MN1 may release one or more communication flows on controlee MN2, such as Audio2 flow between MN2 and CN from the collaborative session.

As shown in FIG. 24, a user of MN1 may trigger releasing a communication flow on MN2. MN1 may send an IUT release flow request over MIP to HA1. HA1 may parse the MIP message from MN1 and may forward the information associated with IUT release flow request to SCCF. SCCF may retrieve information associated with the collaborative session. SCCF may retrieve information indicating that MN2 uses HA2 as the home agent. SCCF may authorize releasing the communication flow, such as Audio2 flow between MN2 and CN.

As shown in FIG. 24, SCCF may communicate the IUT release flow request to HA2. HA2 may process the IUT release flow request and may communicate the IUT release flow request over MIP to MN2 for approval. MN2 may accept the IUT release flow request. For example, an application dialog between MN2 and CN may be carried out to release the communication flow such as Audio2. As shown, MN2 may send an IUT release flow response over MIP to HA2. HA2 may parse the MIP message from MN2 and may forward the information associated with the IUT release flow response to SCCF.

As described above, SCCF may maintain information associated with collaborative sessions. Upon receipt of the IUT release flow response, SCCF may update information associated with the collaborative session to reflect that the communication flow is released from the collaboration session. The information associated with the collaborative session maintained at SCCF may be accessible to the nodes associated with the collaborative session.

In an embodiment, SCCF may communicate the IUT release flow request to the CN. CN may accept the release flow request. For example, CN may close the communication flow to MN2 based on the IUT release flow request. In an embodiment, the flow release processes may be initiated from a client side such as MN1 and MN2, and the CN may not need to be contacted to complete an IUT flow release.

As shown in FIG. 24, SCCF may communicate the IUT release flow response to HA1. HA1 may process the IUT release flow response and may communicate the IUT release flow response over MIP to MN1. Upon completion of releasing a communication flow such as Audio2 between MN2 and CN from the collaboration session, Video1 flow may be left between MN2 and CN, and Audio1 flow may be between MN1 and CN in the collaborative session.

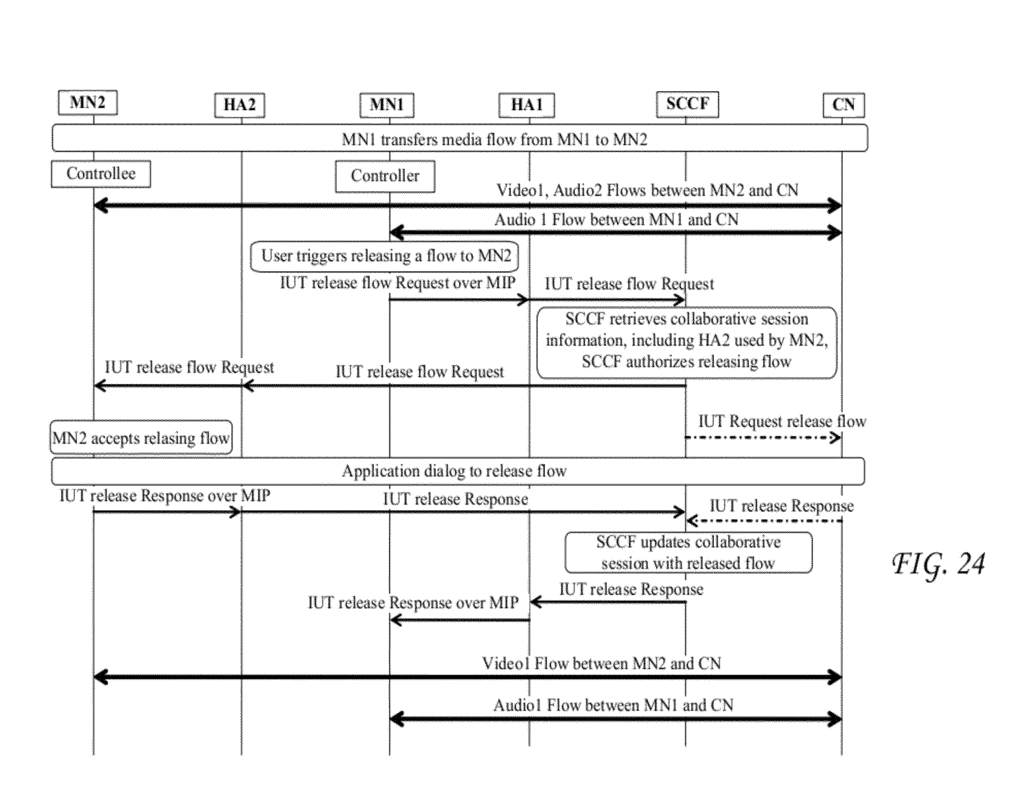

FIG. 25 illustrates an exemplary embodiment of a collaborative session action where a controlee releases a flow on the controlee. As shown, MN1 may be the controller of a collaborative session, and MN2 may be the controlee of the collaborative session. There may be one or more communication flows such as Video1 and Audio2 flows between MN2 and CN. There may be one or more communication flows such as Audio1 flow between MN1 and CN. For example, MN2 may release one or more communication flows on MN2 itself, such as Audio2 flow between MN2 and CN to the collaborative session.

As shown in FIG. 25, a user of MN2 may trigger releasing a communication flow on MN2. For example, an application dialog between MN2 and CN may be carried out to release a communication flow such as Audio2 flow. As shown, MN2 may send an IUT flow release indication over MIP to HA2. HA2 may parse the MIP message from MN2 and may forward the information associated with the IUT flow release indication to SCCF.

As described above, SCCF may maintain information associated with collaborative sessions. Upon receipt of the IUT release flow indication, SCCF may update information associated with the collaborative session to reflect that the communication flow is released from the collaboration session. As shown in FIG. 25, SCCF may communicate an IUT release flow indication to HA1. HA1 may process the IUT release flow indication and may communicate the IUT release flow indication over MIP to MN1. The IUT release flow indication over MIP may include an IUT release indication MIP message, which will be described in more detail below.

As shown in FIG. 25, upon receipt of the IUT release flow indication over MIP, MN1 may update the information associated with flows on MN2 to reflect that the communication flow is released from the collaboration session. In an embodiment, MN1 may maintain information associated with flows on controlees such as MN2 at MN1. As shown, MN1 may send an IUT release indication acknowledgement over MIP to HA1. An IUT release indication acknowledgement over MIP may include an IUT release indication acknowledgment MIP message, which will be described in more detail below. HA1 may parse the MIP message from MN1 and may forward the information associated with IUT release indication acknowledgement to SCCF. As shown in FIG. 25, SCCF may communicate the IUT release indication acknowledgement to HA2. HA2 may process the IUT release indication acknowledgement and may communicate the IUT release indication acknowledgement over MIP to MN2.

Upon completion of releasing a communication flow such as Audio2 between MN2 and CN from the collaboration session, Video1 flow may be left between MN2 and CN, and Audio1 flow may be between MN1 and CN in the collaborative session.

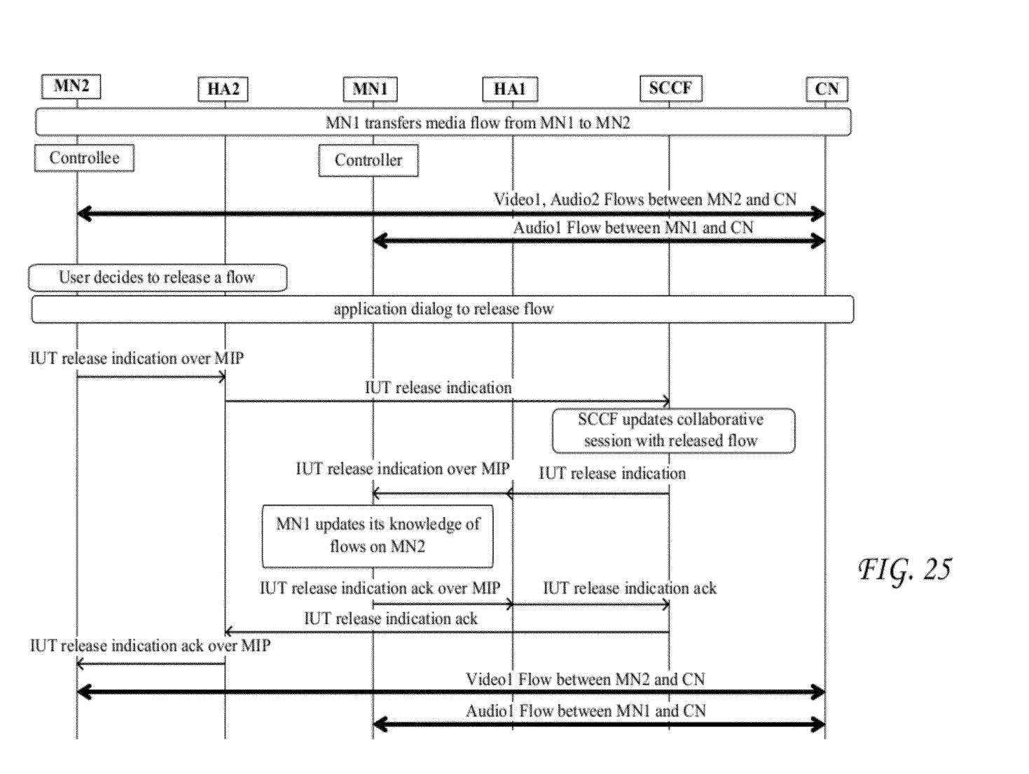

FIG. 26 illustrates an exemplary embodiment of a collaborative session action where a controlee modifies a flow on the controlee. As shown, MN1 may be the controller of a collaborative session, and MN2 may be the controlee of the collaborative session. There may be a communication flow such as Video1 flow between MN2 and CN. There may be one or more communication flows such as Audio1 and Audio2 flows between MN1 and CN. For example, MN2 may initiate an update of a communication flow such as Video1 flow between MN2 and CN.

As shown in FIG. 26, a user of MN2 may trigger a flow update on a communication flow associated with MN2 such as Video1 flow between MN2 and CN. For example, an application specific dialog between MN2 and CN may modify the communication flow between MN2 and CN. As shown in FIG. 26, MN2 may send an IUT modify flow indication over MIP to HA2. HA2 may parse the MIP message from MN2 and may forward the information associated with the IUT modify flow indication to SCCF.

As described above, SCCF may maintain information associated with collaborative sessions. Upon receipt of the IUT modify flow indication, SCCF may update information associated with the collaborative session to reflect the modification to the communication flow. The information associated with the collaborative session maintained at SCCF may be accessible to the nodes associated with the collaborative session.

As shown in FIG. 26, SCCF may communicate the IUT modify flow indication to HA1. HA1 may process the IUT modify flow indication and may communicate the IUT modify flow indication over MIP to MN1.

As described above, MN1 may maintain information associated with flows on controlees such as MN2. As shown in FIG. 26, upon receipt of the IUT modify flow indication over MIP, MN1 may update the information associated with flows on MN2 to reflect that the communication flow is modified. As shown, MN1 may send an IUT modify flow indication acknowledgement over MIP to HA1. HA1 may parse the MIP message from MN1 and may forward the information associated with IUT modify flow indication acknowledgement to SCCF. As shown, SCCF may communicate the IUT modify flow indication acknowledgement to HA2. HA2 may process the IUT modify flow indication acknowledgement and may communicate the IUT modify flow indication acknowledgement over MIP to MN2. As shown, upon completion of the flow modification, modified Video1 flow may be carried out between MN2 and CN.

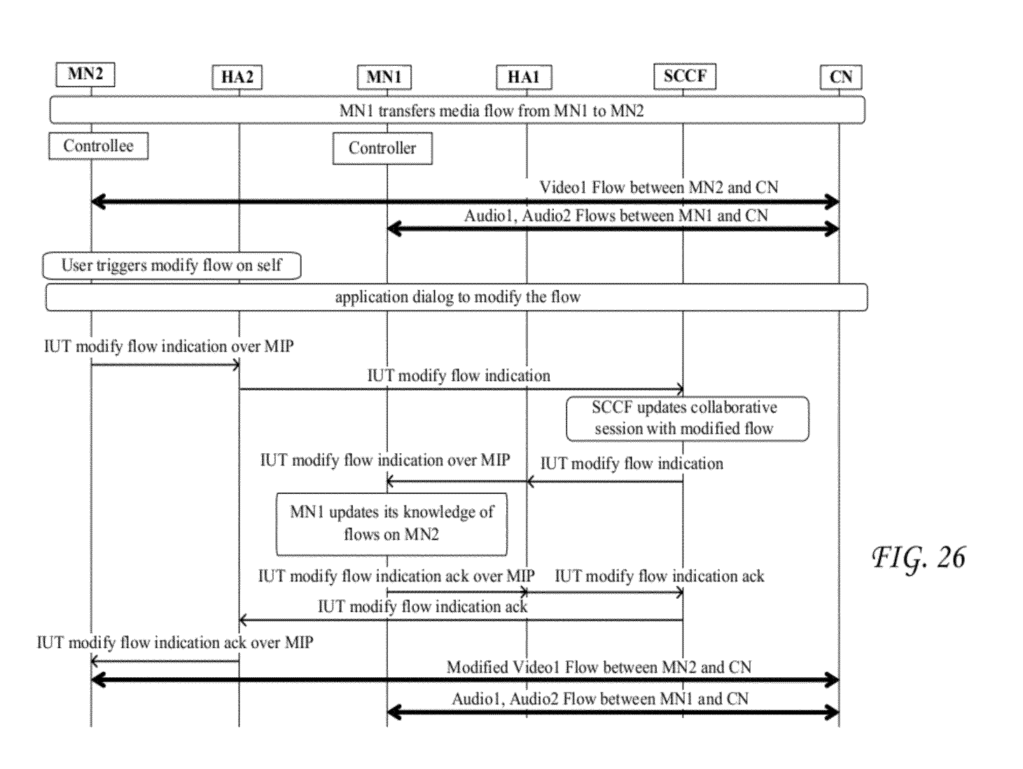

FIG. 27 illustrates an exemplary embodiment of a collaborative session action where a remote party releases a communication flow. As shown, MN1 may be the controller of a collaborative session, and MN2 may be the controlee of the collaborative session. There may be one or more communication flows such as Video1 and Audio2 flows between MN2 and CN. There may be one or more communication flows such as Audio1 flow between MN2 and CN. For example, CN may release a communication flow such as Audio2 flow between MN2 and CN from the collaborative session. For example, an application dialog between MN2 and CN may be carried out to release a communication flow such as Audio2 flow.

In an embodiment, as shown in FIG. 27, MN2 may detect the end of the communication flow, and may inform SCCF. For example, MN2 may send an IUT flow release indication over MIP to HA2. HA2 may parse the MIP message from MN2 and may forward the information associated with the IUT flow release indication to SCCF. In an embodiment, as shown in FIG. 27, CN may inform SCCF of the release of the communication flow. For example, CN may send an IUT flow release indication to SCCF.

As described above, SCCF may maintain information associated with collaborative sessions. Upon receipt of the IUT release flow indication, SCCF may update information associated with the collaborative session to reflect that the communication flow is released from the collaboration session. As shown in FIG. 27, SCCF may communicate an IUT release flow indication to HA1. HA1 may process the IUT release flow indication and may communicate the IUT release flow indication over MIP to MN1. MN1 may update the information associated with flows on MN2 to reflect that the communication flow has been released. As shown, MN1 may send an IUT release indication acknowledgement over MIP to HA1. HA1 may parse the MIP message from MN1 and may forward the information associated with IUT release indication acknowledgement to SCCF.

In an embodiment, as shown in FIG. 27, SCCF may communicate the IUT release indication acknowledgement to HA2. HA2 may process the IUT release indication acknowledgement and may communicate the IUT release indication acknowledgement over MIP to MN2. In an embodiment, as shown in FIG. 27, SCCF may communicate the IUT release indication acknowledgement to CN.

Upon completion of releasing a communication flow such as Audio2 between MN2 and CN from the collaboration session, Video1 flow may be left between MN2 and CN, and Audio1 flow may be between MN1 and CN in the collaborative session.

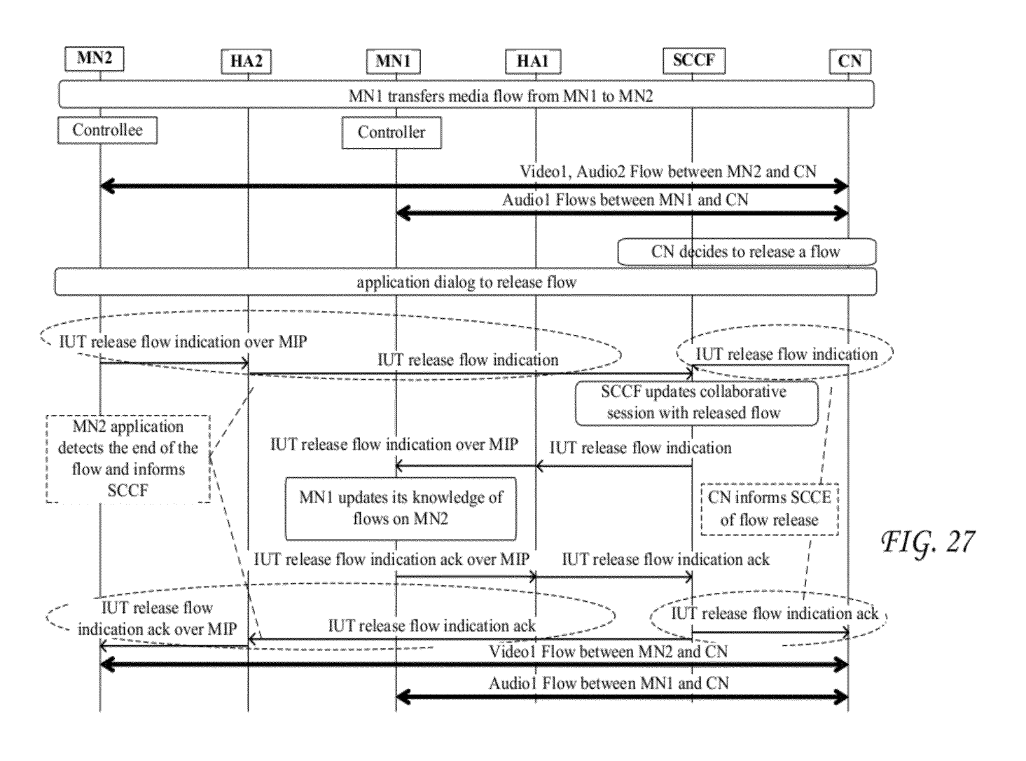

FIG. 28 illustrates an exemplary embodiment of a collaborative session action where a remote party initiates a flow modification. As shown, MN1 may be the controller of a collaborative session, and MN2 may be the controlee of the collaborative session. There may be a communication flow such as Video1 flow between MN2 and CN. There may be one or more communication flows such as Audio1 and Audio2 flows between MN1 and CN. For example, CN may initiate an update of a communication flow such as Video1 flow between MN2 and CN.

As shown in FIG. 28, CN may initiate a modification of the communication flow between MN2 and CN. For example, an application dialog between MN2 and CN may be carried out to modify the communication flow.

In an embodiment, MN2 may detect the modification to the communication flow, and may inform SCCF. For example, MN2 may send an IUT modify flow indication over MIP to HA2. HA2 may parse the MIP message from MN2 and may forward the information associated with the IUT modify flow indication to SCCF. In an embodiment, as shown in FIG. 28, CN may inform SCCF of the modification to the communication flow. For example, CN may send an IUT modify flow indication to SCCF.

As described above, SCCF may maintain information associated with collaborative sessions. Upon receipt of the IUT modify flow indication, SCCF may update information associated with the collaborative session to reflect that the communication flow is modified. As shown in FIG. 28, SCCF may communicate an IUT modify flow indication to HA1. HA1 may process the IUT modify flow indication and may communicate the IUT modify flow indication over MIP to MN1. MN1 may update the information associated with flows on MN2 to reflect that the communication flow has been modified. As shown, MN1 may send an IUT modify flow indication acknowledgement over MIP to HA1. HA1 may parse the MIP message from MN1 and may forward the information associated with IUT modify flow indication acknowledgement to SCCF.

As shown in FIG. 28, SCCF may communicate the IUT modify flow indication acknowledgement to HA2. HA2 may process the IUT modify flow indication acknowledgement and may communicate the IUT modify indication acknowledgement over MIP to MN2. In an embodiment, as shown in FIG. 28, SCCF may communicate the IUT modify flow indication acknowledgement to CN. As shown, upon completion of the flow modification, modified Video1 flow may be carried out between MN2 and CN.

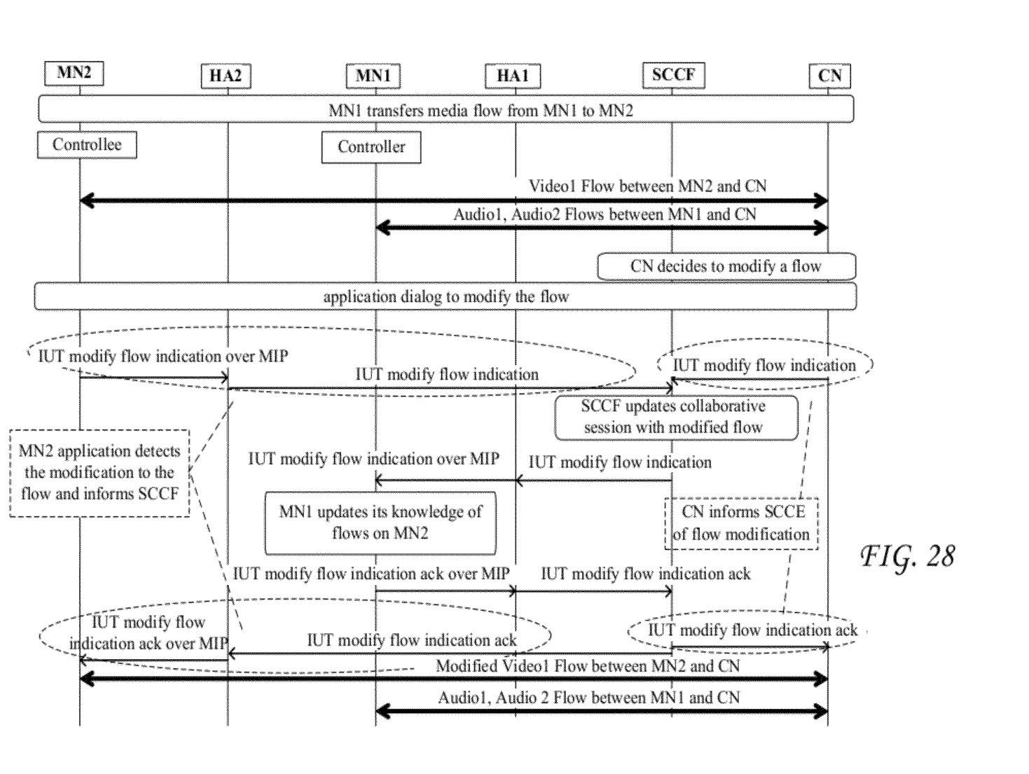

FIG. 29 illustrates an exemplary embodiment of a collaborative session action where a controller releases a collaborative session. For example, the controller may release the communication flow(s) associated with the collaborative session and the collaborative session. As shown, MN1 may be the controller of a collaborative session, and MN2 may be the controlee of the collaborative session. There may be one or more communication flows such as Video1 flow between MN2 and CN. There may be one or more communication flows such as Audio1 flow between MN1 and CN. For example, MN1 may release the communication flow(s) associated with the collaborative session and the collaborative session.

As shown in FIG. 29, a user of MN1 may trigger releasing of the collaborative session. MN1 may send an IUT release collaborative session request over MIP to HA1. An IUT release collaborative session request over MIP may include an IUT release collaborative session request MIP message, which will be described in more detail below. HA1 may parse the MIP message from MN1 and may forward the information associated with IUT release collaborative session request to SCCF. The IUT release collaborative session request may include a unique identifier such as a session ID that may uniquely identify the collaboration session. SCCF may retrieve information associated with the collaborative session based on the session ID. For example, SCCF may identify the communication flows associated with the communication session, and may initiate releasing of the communication flows.

As shown in FIG. 29, SCCF may send a release flow request to HA1. HA1 may process the IUT release flow request and may communicate the IUT release flow request over MIP to MN1. For example, an application dialog between MN1 and CN may be carried out to release the communication flow(s) associated with MN1 in the communication session. For example, an application dialog between MN1 and CN may be carried out to release Audio1 flow. As shown, MN1 may send an IUT release flow response over MIP to HA1. HA1 may parse the MIP message from MN1 and may forward the information associated with the IUT release flow response to SCCF.

As shown in FIG. 29, SCCF may send a release flow request to HA2. HA2 may process the IUT release flow request and may communicate the IUT release flow request over MIP to MN2. For example, an application dialog between MN2 and CN may be carried out to release the communication flow(s) associated with MN2 in the communication session. For example, an application dialog between MN2 and CN may be carried out to release Video1 flow. As shown, MN2 may send an IUT release flow response over MIP to HA2. HA2 may parse the MIP message from MN2 and may forward the information associated with the IUT release flow response to SCCF.

In an embodiment, SCCF may communicate the IUT release flow requests to the CN. CN may accept the release flow requests. For example, CN may close the communication flow to MN1 and MN2 based on the IUT release flow requests. In an embodiment, the flow release processes may be initiated from a client side such as MN1 and MN2, and the CN may not need to be contacted to complete an IUT flow release.

As shown in FIG. 29, SCCF may send an IUT release collaborative session response to HA1. HA1 may process the IUT release collaborative session response and may communicate the IUT release collaborative session response over MIP to MN1. An IUT release collaborative session response over MIP may include an IUT release collaborative session response message, which will be described in more detail below. As shown, upon completion of releasing the collaborative session, there may be no communication flows in the collaborative session. For example, there may be no communication flows between MN1 and CN, and no communication flows between MN2 and CN.

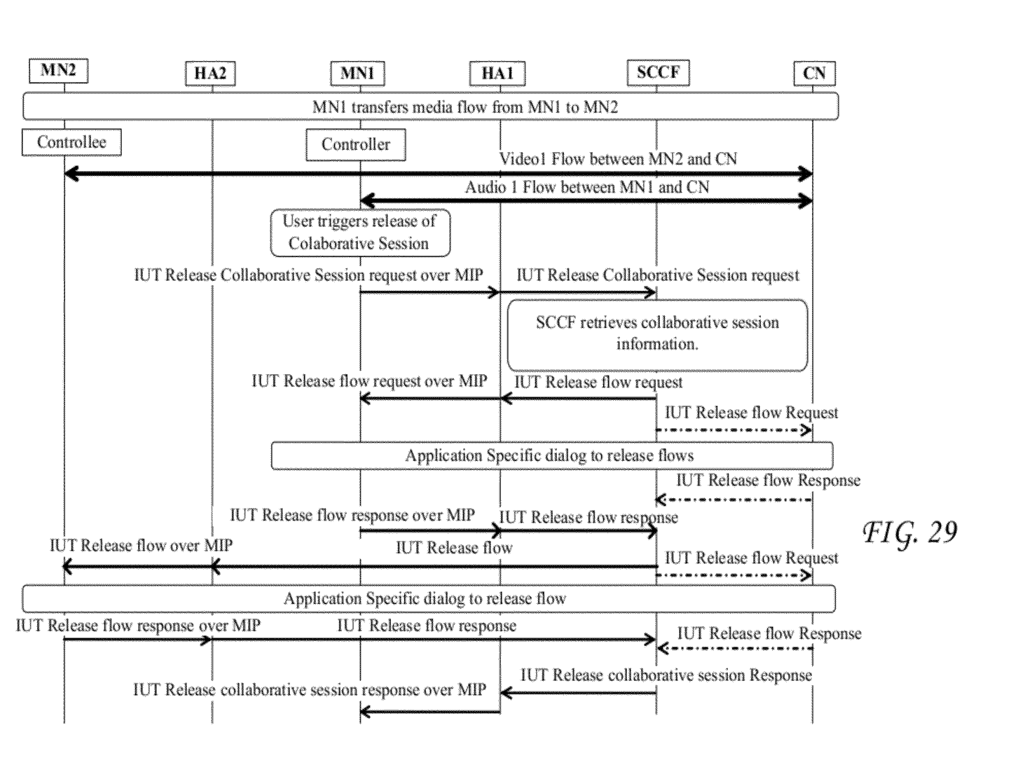

FIG. 30 illustrates an exemplary embodiment of a collaborative session action where a controller transfers the controller role to a controlee. As shown, MN1 may be the controller of a collaborative session, and MN2 may be the controlee of the collaborative session. There may be one or more communication flows such as Video1 and Audio1 flows between MN2 and CN. There may be one or more communication flows such as Audio2 flow between MN2 and CN. For example, MN1 may transfer the controller role to MN2.

As shown in FIG. 30, a user of MN1 may trigger transfer of control over the collaborative session to MN2. As shown, MN1 may send an IUT transfer control request over MIP to HA1. An IUT transfer control request over MIP may include an IUT transfer control request MIP message, which will be described in more detail below. HA1 may parse the MIP message from MN1 and may forward the information associated with the IUT transfer control request to SCCF.

As described above, SCCF may maintain information associated with collaborative sessions. As shown in FIG. 30, SCCF may retrieve information associated with the collaboration session. SCCF may authorize the transfer of control. SCCF may communicate an IUT transfer control request to HA2. HA2 may process the IUT transfer control request and may communicate the IUT transfer control request over MIP to MN2. SCCF may send information associated with the communication flows associated with the collaboration session to MN2 via HA2.

As shown in FIG. 30, MN2 may receive IUT transfer control request and information associated with the communication flows associated with the collaboration session. MN2 may assume the controller role of the collaboration session. As shown, MN2 may send an IUT transfer control response over MIP to HA2. An IUT transfer control response over MIP may include an IUT transfer control response MIP message, which will be described in more detail below. HA2 may parse the MIP message from MN2 and may forward the information associated with the IUT transfer control response to SCCF.

As described above, SCCF may maintain information associated with collaborative sessions. As shown, upon receipt of the IUT transfer control response, SCCF may update information associated with the collaborative session to reflect that MN2 has the controller role of collaboration session. SCCF may send an IUT transfer control response to HA1. HA1 may process the IUT transfer control response and may communicate the IUT transfer control response over MIP to MN1. As shown, upon completion of transferring the control role of the collaborative session, MN1 may be the controlee of a collaborative session, and MN2 may be the controller of the collaborative session.

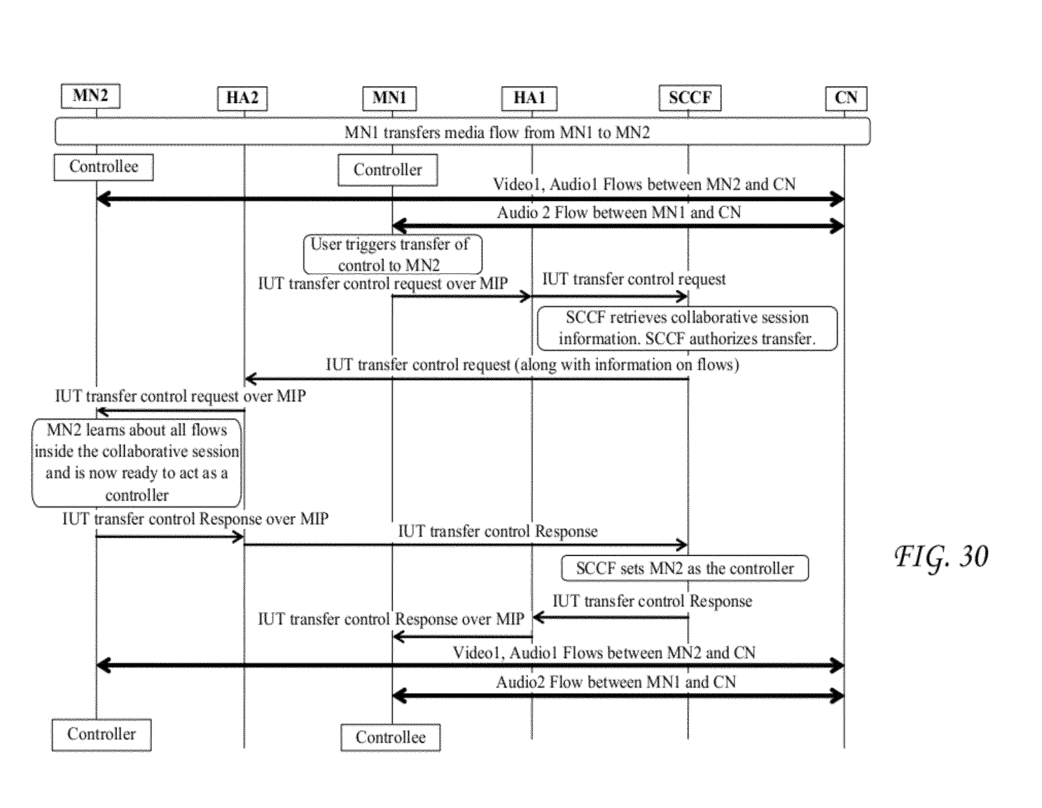

FIG. 31 illustrates an exemplary embodiment of a collaborative session action where a controlee transfers the controller role to the controlee. As shown, MN1 may be the controller of a collaborative session, and MN2 may be the controlee of the collaborative session. There may be one or more communication flows such as Video1 and Audio1 flows between MN2 and CN. There may be one or more communication flows such as Audio2 flow between MN2 and CN. For example, MN2 may transfer the controller role to MN2 itself.

As shown in FIG. 31, a user of MN2 may trigger transfer of control over the collaborative session to MN2 itself. As shown, MN2 may send an IUT transfer control request over MIP to HA2. HA2 may parse the MIP message from MN2 and may forward the information associated with the IUT transfer control request to SCCF.

As described above, SCCF may maintain information associated with collaborative sessions. As shown in FIG. 31, SCCF may retrieve information associated with the collaboration session. SCCF may authorize the transfer of control. SCCF may communicate an IUT transfer control request to HA1. HA1 may process the IUT transfer control request and may communicate the IUT transfer control request over MIP to MN1.

As shown in FIG. 31, MN1 may retrieve information associated with the communication flows associated with the collaboration session, and send the information to SCCF. For example, MN1 may insert the information associated with the communication flows associated with the collaboration session into an IUT transfer control request over MIP. For example, the IUT transfer control request from the SCCF may include little or no data in the message body. MN1 may fill the IUT transfer control request with information associated with the communication flows associated with the collaboration session, and may send the IUT transfer control request to SCCF via HA1.

As shown in FIG. 31, upon receipt of the IUT transfer control request from MN1, SCCF may communicate an IUT transfer control request to HA2. HA2 may process the IUT transfer control request and may communicate the IUT transfer control request over MIP to MN2. SCCF may send information associated with the communication flows associated with the collaboration session to MN2 via HA2. For example, information associated with the communication flows associated with the collaboration session may be included in the IUT transfer control request.

As shown in FIG. 31, MN2 may receive IUT transfer control request and information associated with the communication flows associated with the collaboration session. MN2 may assume the controller role of the collaboration session. As shown, MN2 may send an IUT transfer control response over MIP to HA2. HA2 may parse the MIP message from MN2 and may forward the information associated with the IUT transfer control response to SCCF.

As described above, SCCF may maintain information associated with collaborative sessions. As shown in FIG. 31, upon receipt of the IUT transfer control response, SCCF may update information associated with the collaborative session to reflect that MN2 has the controller role of collaboration session. SCCF may send an IUT transfer control response to HA1. HA1 may process the IUT transfer control response and may communicate the IUT transfer control response over MIP to MN1. As shown, upon completion of transferring the control role of the collaborative session, MN1 may be the controlee of a collaborative session, and MN2 may be the controller of the collaborative session.

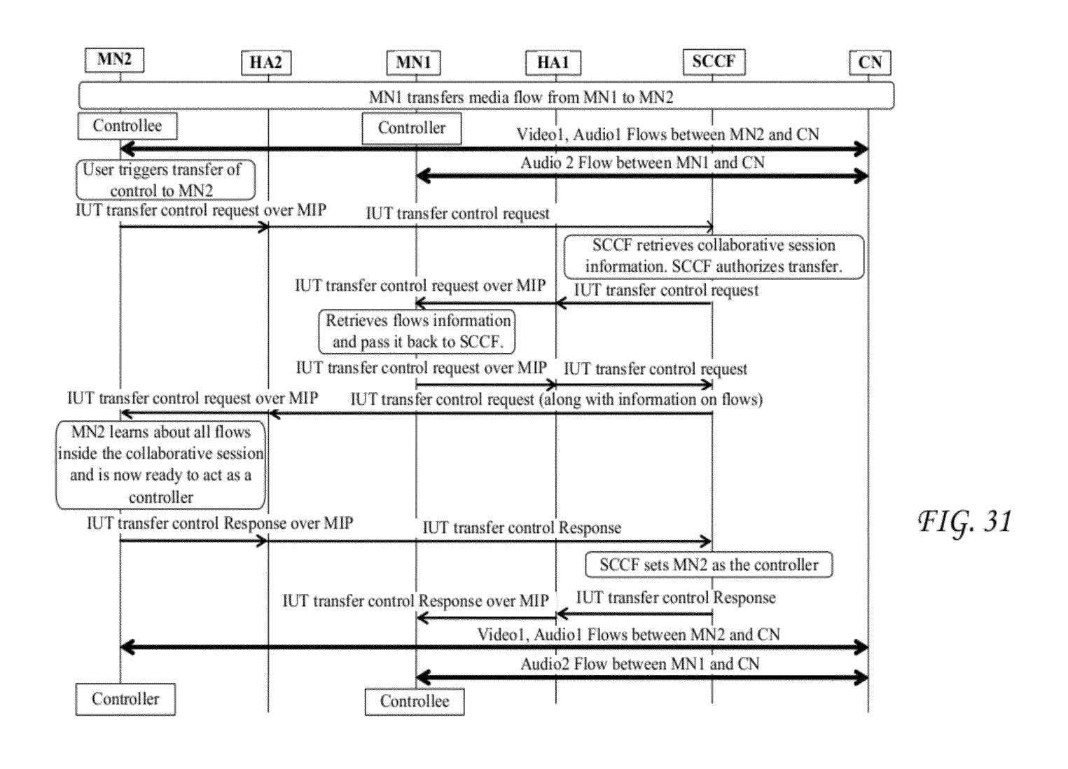

FIG. 32 illustrates an exemplary embodiment of a collaborative session action where an SCCF transfers a session(s). As shown, MN1 may be the controller of a collaborative session, and MN2 may be the controlee of the collaborative session. There may be one or more communication flows such as Video1 flow between MN2 and CN. There may be one or more communication flows such as Audio1 flow between MN1 and CN. For example, an event may trigger the SCCF to initiate an IUT transfer. Events that may trigger the SCCF to initiate an IUT transfer may include, but not limited to, a node such as MN1 losing connectivity, the controller of the collaborative session such as MN1 losing connectivity, network overload, and/or a new node accessing the network. As shown the network may communicate the occurrence of triggering event to SCCF. For example, SCCF may transfer communication flows associated with one node that may have lost network connectivity to another node with network connectivity.

As shown in FIG. 32, network may communicate to SCCF that MN1 has lost its connectivity. SCCF may retrieve information associated with collaborative sessions involving MN1. SCCF may identify a collaborative session involving MN1 and MN2. SCCF may send an IUT transfer request to HA2. HA2 may process the IUT transfer request and may communicate the IUT transfer request over MIP to MN2. MN2 may accept the IUT transfer. For example, an application dialog between MN2 and CN may be carried out to establish a new flow between MN2 and CN. For example, the Audio1 flow between MN1 and CN before MN1 loses connectivity may be resumed between MN2 and CN as a new flow.

In an embodiment, SCCF may communicate the IUT transfer requests to CN. CN may accept the IUT transfer request. For example, CN may close the communication flow to MN1 based on the IUT transfer request. In an embodiment, CN may not need to be contacted to complete the IUT transfer process initiated by SCCF.

As shown in FIG. 32, MN2 may send an IUT transfer response over MIP to HA2. HA2 may parse the MIP message from MN1 and may forward the information associated with the IUT transfer response to SCCF. Upon completion of the IUT transfer, there may be no communication flows between MN1 and CN, and Video1 and Audio1 flows may exist between MN2 and CN.

Components of a collaborative session system such as SCCF(s), MN(s), HA(s) and CN(s) may identify the collaborative session using a collaborative session ID. The collaborative session ID may be used to match a request related to a collaboration session with an existing collaborative session. A collaborative session ID may be formed by combining or concatenating several fields related to the request. For example, fields such as a source of the original IUT request and an ID of the original IUT request, a timestamp and/or other values that may be unique on the given host, may be jointly form a collaboration session ID. In an embodiment, an IUT related message related to a collaborative session may have a unique identification used to identify the collaboration session.

In an embodiment, an IUT related message may include information that may be used to retrieve the session ID. For example, a response may refer to an ID of the request, which may be used to retrieve the collaborative session ID, for example, at SCCF and/or other nodes that may store the collaborative session ID associated with the request.

As described above, MIP messages may be used to carry IUT related information. For example, between the mobile nodes and their home agents over an MIP interface. IUT related information may be carried over an applicable protocol over SCCa. In an embodiment, the format of the IUT related messages may differ, but the message body content may stay the same.

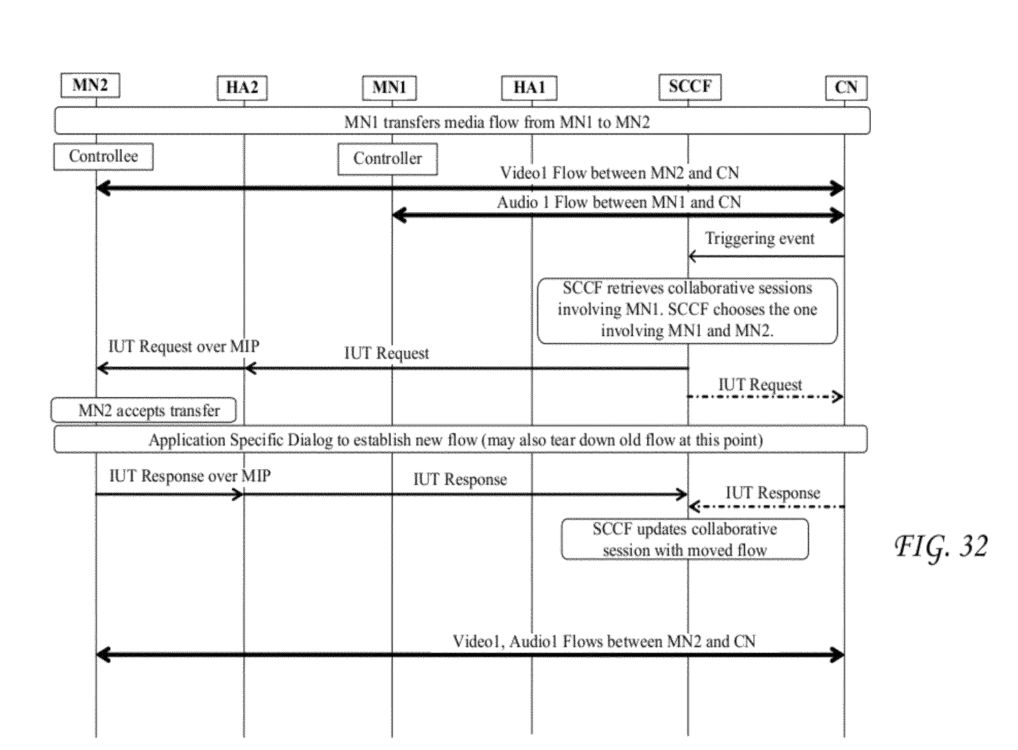

FIG. 33 illustrates an exemplary embodiment of an IUT over MIP message structure. As shown, an IUT over MIP message may include an IUT type field and a detail of message body content for IUT types. The message body part of FIG. 33 may support various operations such as those described with respect to FIGS. 16-32. The message body part may be described in detail below in relation to exemplary IUT types.

For example, a node may request a flow transfer by sending an IUT request message. The IUT request message may have an IUT type value of 0. The body content of an IUT request message may include, but not limited to, a collaboration session ID, a source identification, a destination identification and/or a correspondent nodes identification, node flow information such as QoS, codec of the node originating the request, application name or media type, and/or application specific parameter(s) such as ports and/or current position in the flow. For example, the source identification, the destination identification and/or the correspondent nodes identification may include an IP address.

For example, a node may reply after a transfer takes place by sending an IUT response message. A node or an SCCF may also reject an IUT request by sending an IUT response message. The IUT response message may have an IUT type value of 1. For example, the IUT response message may include an IUT code that may indicate an IUT operation success, an IUT operation failure, and/or an IUT request is denied. An IUT response message may include, but not limited to, a collaboration session ID, a source identification, a destination identification and/or a correspondent nodes identification, node flow information related to the node originating the response such as QoS and codec, application name or media type, and/or application specific parameter(s) such as ports and/or current position in the flow.

For example, a node may send an indication after a transfer has taken place. For example, the node may send an IUT transfer indication message. The IUT indication message may have an IUT type value of 2. For example, the IUT indication message may include an identifier that may identify a collaboration session such as a collaboration session ID. The IUT message may include but not limited to, a source identification, a destination identification and/or a correspondent nodes identification, node flow information related such as QoS and codec, an application name or a media type, and/or application specific parameter(s) such as ports and/or current position in the flow.

For example, an acknowledgment such as an IUT transfer indication acknowledgment message (“IUT Transfer Indication Ack message”) may be sent to acknowledge that an IUT transfer indication has been acted upon an indication after a transfer has taken place. The IUT Transfer Indication Ack message may have an IUT type value of 3. For example, the IUT Transfer Indication Ack message may include an identifier that may identify a collaboration session such as a collaboration session ID.

For example, a modification request such as an IUT modify message may be sent to request for modification of an existing IUT flow. The IUT modify message may have an IUT type value of 4. For example, the IUT modify message may include an identifier that may identify a collaboration session such as a collaboration session ID. The IUT modify message may include an identifier that may identify an MN end point and an identifier that may identify correspondent node(s). For example, the MN end point and correspondent node(s) may be identified using corresponding IP addresses. The IUT modify message may include a indication of the requested modification to the IUT. For example, the IUT modify message may include, node flow information such as QoS and codec, an application name or a media type, and/or application specific parameter(s) such as ports and/or current position in the flow.

For example, a reply such as an IUT modify response message may be sent after a requested modification takes place. The IUT modify response message may have an IUT type value of 5. The IUT modify response message may include an identifier that may identify a collaboration session such as a collaboration session ID.

For example, an indication of an IUT flow modification has occurred such as an IUT modification indication message (“IUT Modification Indication” message) may be sent. The IUT Modification Indication message may include an identifier that may identify a collaboration session such as a collaboration session ID. The IUT Modification Indication message may have an IUT type value of 6. For example, the IUT Modification Indication message may include an identifier that may identify a collaboration session such as a collaboration session ID. The IUT Modification Indication message may include an identifier that may identify an MN end point and an identifier that may identify correspondent node(s). For example, the MN end point and correspondent node(s) may be identified using corresponding IP addresses. For example, the IUT Modification Indication message may include node flow information such as QoS and codec, an application name or a media type, and/or application specific parameter(s) such as ports and/or current position in the flow.

For example, an acknowledgment such as an IUT modification indication ack message (“IUT Modification Indication Ack message”) may be sent to acknowledge that an IUT modification indication has been acted upon an indication. The IUT Modification Indication Ack message may have an IUT type value of 7. For example, the IUT Modification Indication Ack message may include an identifier that may identify a collaboration session such as a collaboration session ID.

For example, a release request such as an IUT release message may be sent to request for releasing an existing IUT flow. The IUT release message may have an IUT type value of 8. For example, the IUT release message may include an identifier that may identify a collaboration session associated with the request such as a collaboration session ID. The IUT release message may include an identifier that may identify an MN end point and an identifier that may identify correspondent node(s). For example, the MN end point and correspondent node(s) may be identified using corresponding IP addresses. The IUT release message may include information that may identify the flow to release, for example, an application name or a media type, and/or application specific parameter(s) such as ports.

For example, a reply such as an IUT release response message may be sent after a requested release takes place. The IUT release response message may have an IUT type value of 9. The IUT release response message may include an identifier that may identify a collaboration session such as a collaboration session ID.

For example, an indication of an IUT flow release has occurred such as an IUT release indication message may be sent. The IUT release indication message may include an identifier that may identify a collaboration session such as a collaboration session ID. The IUT release indication message may have an IUT type value of 10. For example, the IUT release indication message may include an identifier that may identify a collaboration session such as a collaboration session ID. The IUT release indication message may include an identifier that may identify an MN end point and an identifier that may identify correspondent node(s). The IUT release message may include information that may identify the flow associated with the release, for example, an application name or a media type, and/or application specific parameter(s) such as ports.

For example, an acknowledgment such as an IUT release indication acknowledgment message may be sent to acknowledge that an IUT release indication has been acted upon. The IUT release indication acknowledgment message may have an IUT type value of 11. For example, the IUT release indication acknowledgment message may include an identifier that may identify a collaboration session such as a collaboration session ID.

For example, an add flow request such as an IUT add flow message may be sent to request a new flow to be added to a collaboration session. The IUT add flow message may have an IUT type value of 12. For example, the IUT add flow message may include an identifier that may identify a collaboration session such as a collaboration session ID. The IUT add flow message may include an identifier that may identify an MN end point and an identifier that may identify correspondent node(s). For example, the MN end point and correspondent node(s) may be identified using corresponding IP addresses. For example, the IUT add flow message may include node flow information such as QoS and codec. For example, the IUT add flow message may include an application name or a media type, and/or application specific parameter(s).

For example, a reply such as an IUT add flow response message may be sent after a requested a flow has been added or state update takes place. The IUT add flow response message may have an IUT type value of 13. The IUT add flow response message may include an identifier that may identify a collaboration session such as a collaboration session ID. The IUT add flow response message may include flow information updated to reflect the flow settings. For example, the IUT add flow response message may include information such that the SCCF and the controller may update their knowledge of the flows associated with the collaborative session.

For example, an indication that an IUT flow addition has occurred, such as an IUT add flow indication message, may be sent. The IUT add flow indication message may include an identifier that may identify a collaboration session such as a collaboration session ID. The IUT add flow indication message may have an IUT type value of 14. For example, the IUT add flow indication message may include an identifier that may identify a collaboration session such as a collaboration session ID. The IUT add flow indication message may include an identifier that may identify an MN end point and an identifier that may identify correspondent node(s). For example, the MN end point and correspondent node(s) may be identified using corresponding IP addresses. For example, the IUT add flow indication message may include node flow information such as QoS and codec, an application name or a media type, and/or application specific parameter(s) such as ports and/or current position in the flow.

For example, an acknowledgment such as an IUT add flow indication acknowledgment message may be sent to acknowledge that an IUT add flow indication has been acted upon. The IUT flow indication acknowledgment message may have an IUT type value of 15. For example, the IUT flow indication acknowledgment message may include an identifier that may identify a collaboration session such as a collaboration session ID.

For example, a release collaborative session request such as an IUT release collaborative session request message may be sent to request for release of the collaboration session. The IUT release collaborative session request message may have an IUT type value of 16. For example, the IUT release collaborative session request message may include an identifier that may identify a collaboration session to be released, such as a collaboration session ID.

For example, a reply such as an IUT release collaborative session response message may be sent after a requested collaborative session release takes place. For example, the SCCF may send the IUT release collaborative session response message after the collaborative session release took place. The IUT release collaborative session response message may have an IUT type value of 17. The IUT release collaborative session response message may include an identifier that may identify a collaboration session such as a collaboration session ID.

For example, a transfer control request such as an IUT transfer control request message may be sent to request for transferring a collaborative session control session. The IUT transfer control request message may have an IUT type value of 18. For example, the IUT transfer control request message may include an identifier that may identify a collaboration session such as a collaboration session ID. The IUT transfer control request message may include an identifier that may identify an MN end point and an identifier that may identify correspondent node(s). For example, the MN end point and correspondent node(s) may be identified using corresponding IP addresses. The IUT transfer control request message may information associated with the flow(s) in the collaborative session

For example, a reply such as an IUT transfer control response message may be sent after the transfer of the control session has been be completed. For example, an IUT transfer control response message may be sent to indicate a denial of a transfer control request. The IUT transfer control response message may have an IUT type value of 19. The IUT transfer control response message may include an identifier that may identify a collaboration session such as a collaboration session ID.

In an embodiment, an MIP interface may be implemented between SCCF and MN1/MN2. For example, the SCCF may directly send and/or receive IUT related MIP messages to and/or from MN1 and MN2. Home agents such as HA1 and HA2 may not be involved when the SCCF and MNs exchange information, except as part of the normal IP traffic routing.

In an embodiment, multiple SCCF nodes may used, for example, for load, deployment or other reasons. In an embodiment, an SCCF and an HA may be collocated. The SCCF-HA interface may be performed using function calls. In an embodiment, be a single HA may be associated with multiple MNs such as MN1 and MN2. For example, an HA may correspond to a group of MNs, where IUT may be implemented within the group. Having a single HA supporting a group of MNs may reduce complexity and cost.

While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for transferring a communication flow, the method comprising:
receiving an indication to transfer the communication flow from a first node to a second node; and
sending a communication flow transfer request associated with the communication flow via mobile internet protocol.

2. The method of claim 1, further comprising:
receiving a communication flow transfer response via mobile internet protocol indicating that the communication flow transfer request has been accepted; and
terminating the communication flow at the first node.

3. The method of claim 2, wherein the communication flow transfer response comprises a mobile internet protocol message, the mobile internet protocol message comprising information indicative of at least one of:
an indicator identifying the communication flow transfer message;
a type of the communication flow transfer message;
a response code;
an address of the first node;
an address of the second node for transferring the communication flow;
an address of a correspondence node;
a session continuity parameter; and
an application specific parameter.

4. The method of claim 1, wherein the communication flow transfer request comprises a mobile internet protocol message, the mobile internet protocol message comprising:
an indicator identifying the communication flow transfer message;
a type of the communication flow transfer message; and
a description of the communication flow transfer message.

5. The method of claim 4, wherein the description of the communication flow transfer message further comprises:
an address of the first node;
an address of the second node;
an address of a correspondence node;
a session continuity parameter; and
an application specific parameter.

6. A method for transferring a communication flow, the method comprising:
receiving a request to transfer the communication flow from a first node to a second node, wherein the request originated from the first node via mobile internet protocol;
forwarding the request for delivery to the second node;
receiving a response to the request indicating that the second node has accepted the request, wherein the response originated from the second node via mobile internet protocol; and
instructing a correspondence node to transfer the communication flow to the second node.

7. The method of claim 6, further comprising:
authorizing the request to transfer the communication flow.

8. The method of claim 6, further comprising:
sending an indication that the communication flow has been transferred.

9. The method of claim 6, wherein forwarding the request comprises:
determining a home agent associated with the second node; and
forwarding the request to the home agent associated with the second node for delivery to the second node via mobile internet protocol.

10. The method of claim 6, wherein forwarding the request comprises sending the request to the second node via mobile internet protocol.

11. A wireless transmit and receive unit (WTRU) configured to transfer a communication flow, the WTRU comprising:
a transceiver configured to:
receive an indication to transfer the communication flow to a second WTRU;
send a communication flow transfer request associated with the communication flow via mobile internet protocol; and
receive a communication flow transfer response via mobile internet protocol indicating that the communication flow transfer request has been accepted; and
a processor configured to terminate the communication flow at the WTRU.

12. The WTRU of claim 11, further comprising:
a memory having stored thereon:
an application configured to carry out the communication flow;
an inter-user equipment service program; and
a mobile internet protocol stack.

13. The WTRU of claim 12, wherein the indication to transfer the communication flow comprises information associated with the communication flow, and the processor is further configured to:
instruct the mobile internet protocol stack to encapsulate the information associated with the communication flow in a mobile internet protocol message, wherein the mobile internet protocol message is sent as part of the communication flow transfer request.

14. The WTRU of claim 12, wherein the processor is further configured to:
receive, at the inter-user equipment service program, an indication that the communication flow has been transferred; and
send an indication, at the inter-user equipment service program, to the application that the communication flow transfer has been completed, wherein the application terminates the communication flow at the WTRU.

15. A network device comprising:
a transceiver configured to:
receive a request to transfer a communication flow from a first WTRU to a second WTRU, wherein the request originated from the first WTRU via mobile internet protocol;
forward the request for delivery to the second WTRU; and
receive a response to the request indicating that the second WTRU has accepted the request, wherein the response originated from the second WTRU via mobile internet protocol; and
a processor configured to:
provide instructions for a correspondence node to transfer the communication flow to the second WTRU.

16. The network device of claim 15, wherein the processor is further configured to:
authorize the request to transfer the communication flow.

17. The network device of claim 15, wherein the processor is further configured to:
provide an indication for the first WTRU that the communication flow has been transferred.

18. The network device of claim 15, wherein the processor is further configured to determine a home agent associated with the second WTRU, and the transceiver is further configured to forward the request to the home agent associated with the second WTRU for delivery to the second WTRU via mobile internet protocol.

19. The network device of claim 15, wherein the processor is further configured to provide instructions to transfer the communication flow to the second WTRU via mobile internet protocol.

20. The network device of claim 15, further comprising a memory having information associated with the communication flow stored thereon.
